(19) United States
(12) Patent Application Publication
(10) Pub. No.: US 2008/0187748 A1
(43) Pub. Date: Aug. 7, 2008

(54) ORGANIC ELECTROLUMINESCENCE DEVICE

(76) Inventor: Masayuki MISHIMA, Kanagawa (JP)

Correspondence Address: BIRCH STEWART KOLASCH & BIRCH, PO BOX 747, FALLS CHURCH, VA, 22040-0747, US

(21) Appl. No.: 12/024,892

(22) Filed: Feb. 1, 2008

(30) Foreign Application Priority Data
Feb. 7, 2007 (JP) 2007-028453
Dec. 11, 2007 (JP) 2007-319897

(51) Int. Cl. H01J 1/63

(52) U.S. Cl. 428/336

(57) ABSTRACT

An organic electroluminescence device including a light-emitting layer which contains at least a first light-emitting material, a second light-emitting material, and an electrically inactive material having an energy difference between a highest occupied molecular orbital and a lowest unoccupied molecular orbital of 4.0 eV or larger, wherein the first light-emitting material is an electron-transporting material, the second light-emitting material is a hole-transporting material, and the light-emitting layer has a thickness within a range of from 0.5 nm to 20 nm.

### CROSS-REFERENCE TO RELATED APPLICATION

This application claims priority under 35 USC 119 from Japanese Patent Application Nos. 2007-028453 and 2007-319897, the disclosures of which are incorporated by reference herein.

### BACKGROUND OF THE INVENTION

1. Field of the Invention

The present invention relates to an organic electroluminescence device (which is referred to hereinafter as an “organic EL device” in some cases), and more particularly to an organic EL device having high light-emission efficiency and excellent in drive durability.

2. Description of the Related Art

Organic electroluminescence devices, containing a thin film material that emits light by excitation due to supply of current, are known. The organic electroluminescence devices are capable of providing a light emission of a high luminance at a low voltage and thus have broad potential applications in fields such as cellular phone displays, personal digital assistants (PDA), computer displays, car information displays, TV monitors and ordinary illumination, and also have advantages of reducing the thickness, weight, size and power consumption of the devices in the respective fields. Accordingly, such devices are greatly expected to become the leading devices in the future electronic display market. However, there are still many technical problems to be overcome, such as with respect to luminance and color tone, durability under various ambient operating conditions, and mass productivity at low cost, in order for these devices to be practically used in these fields in place of the conventional display devices.

Particularly important issues include an improvement in the light emission efficiency and an improvement in the drive durability. In the aforementioned various devices, realization of a higher luminance has been a first issue for realizing reductions in the thickness, weight and size of the device. In realizing reductions in the thickness and weight of the device, reductions in the size and weight are required not only in the device but also in a driving power source. Particularly when the electric power is supplied from a primary battery or a secondary battery, power saving is an important issue, and it is strongly desired to obtain a high luminance at a low driving voltage. In the past, a higher voltage has been required in order to obtain a higher luminance, thus having resulted in an increased electric power consumption. Also, a higher luminance and a higher voltage have resulted in a deterioration of the durability of the device.

For example, JP-A No. 2006-135295 proposes a technology of employing a phosphorescent dopant and two or more phosphorescent host materials as the light-emitting layer. The two phosphorescent host materials preferably have a difference in the triplet energy level of from 2.3 eV to 3.5 eV and are used in a mixing ratio of from 3:1 to 1:3 by mass ratio. However, the combined use of two such host materials is unable to provide a sufficient improvement in the light emission efficiency and in the drive durability.

Also, JP-A No. 2000-106277 proposes to use an aromatic polycyclic hydrocarbon compound, a light emission material including a fluorescent dye and a host material as the light-emitting layer. The aromatic polycyclic hydrocarbon compound has a faster hole mobility than in the host material, and is used for the purpose of suppressing accumulation of holes in the light-emitting layer. However, such a formulation is unable to provide a sufficient improvement in either of the light emission efficiency and the drive durability.

On the other hand, JP-W No. 2004-526284 discloses, for an organic EL device of blue light emission, a light-emitting layer containing a phosphorescence-emitting dopant material and a charge-transport dopant material, doped in an inactive host material. According to the disclosure, plural host materials having an energy gap of 3.5 eV or higher are used in combination for preparing a blue light-emitting organic EL device. Such a construction, however, increases the resistance of the light-emitting layer to result in a large increase in the driving voltage, and a reduction in the thickness of the light-emitting layer for reducing the driving voltage deteriorates the drive durability.

Also, JP-A No. 2005-294250 discloses an organic electroluminescence device in which the light-emitting layer contains a light-emitting material and an electrically inactive material having an energy difference (Eg) between a highest occupied molecular orbital and a lowest unoccupied molecular orbital of 4.0 eV or larger. However, such a construction still involves a problem that the resistance of the light-emitting layer is increased to result in a large increase in the driving voltage, and a reduction in the thickness of the light-emitting layer for reducing the driving voltage deteriorates the drive durability.

### SUMMARY OF THE INVENTION

The present invention has been made in view of the above circumstances and provides an organic electroluminescence device with the following aspect.

An aspect of the invention is to provide an organic electroluminescence device comprising, between a pair of electrodes opposed to each other, an organic compound layer including at least a light-emitting layer, wherein the light-emitting layer contains at least a light-emitting material, and an electrically inactive material having an energy difference (Eg) between a highest occupied molecular orbital and a lowest unoccupied molecular orbital of 4.0 eV or larger, wherein:

the light-emitting material contains at least a first light-emitting material and a second light-emitting material,

the first light-emitting material is an electron-transporting light-emitting material,

the second light-emitting material is a hole-transporting light-emitting material, and

the light-emitting layer has a thickness within a range of from 0.5 nm to 20 nm.

### DESCRIPTION OF THE PREFERRED EMBODIMENTS

The above-described objects of the present invention have been achieved by the following means.

An organic electroluminescence device of the present invention is characterized in that it comprises an organic compound layer including at least a light-emitting layer between a pair of electrodes opposed to each other, wherein the light-emitting layer contains at least a light-emitting material, and an electrically inactive material having an energy difference (Eg) between a highest occupied molecular orbital and a lowest unoccupied molecular orbital of 4.0 eV or larger, wherein the light-emitting material contains at least a first light-emitting material and a second light-emitting material, the first light-emitting material is an electron-transporting light-emitting material, the second light-emitting material is a hole-transporting light-emitting material, and the light-emitting layer has a thickness within a range of from 0.5 nm to 20 nm.

Preferably, an electron affinity (Ea1) of the first light-emitting material is larger than an electron affinity (Ea2) of the second light-emitting material, and also an ionization potential (Ip1) of the first light-emitting material is larger than an ionization potential (Ip2) of the second light-emitting material.

Preferably, the first light-emitting material is a platinum complex.

Preferably, the second light-emitting material is an iridium complex. More preferably, the first light-emitting material is a platinum complex, and the second light-emitting material is an iridium complex.

Preferably, the light-emitting layer has a thickness within a range of from 1 nm to 10 nm.

Preferably, a proportion of the light-emitting materials with respect to a total amount of the light-emitting materials and the electrically inactive material in the light-emitting layer is from 5% to 40% by weight.

Preferably, the electrically inactive material is an organic compound having an ionization potential (Ip) larger than that of the light-emitting material. More preferably, the electrically inactive material is an organic compound having an electron affinity (Ea) smaller than that of the light-emitting material.

Preferably, the electrically inactive material is an aromatic hydrocarbon compound. More preferably, the aromatic hydrocarbon compound is a compound represented by the following formula (1):

L-(Ar)ₘ Formula (1)

In the formula (1), Ar represents a group represented by the following formula (2), L represents a benzene skeleton having a volence of 3 or more, and m represents an integer of 3 or more.

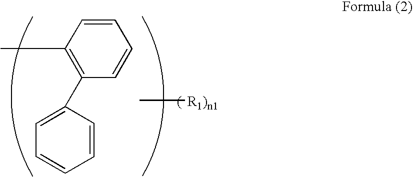

In formula (2), R¹ represents a substituent, with a proviso that, if plural R¹s are present, R¹s may be the same or different from each other, and n1 represents an integer from 0 to 9.

Another preferable embodiment of the aromatic hydrocarbon compound are a compound represented by the following formula (3).

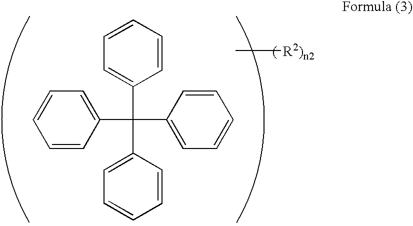

In formula (3), R² represents a substituent, with a proviso that, if plural R²s are present, R²s may be the same or different from each other, and n2 represents an integer from 0 to 20.

Preferably, the electrically inactive material is an insulating inorganic compound.

Preferably, the organic compound layer includes, from an anode side, at least either one of a hole injection layer and a hole transport layer, the light-emitting layer, and at least either one of an electron transport layer and an electron injection layer, and at least either one of the hole injection layer and the hole transport layer contains an electron-accepting material.

Preferably, the organic compound layer includes, from an anode side, at least either one of a hole injection layer and a hole transport layer, the light-emitting layer, and at least either one of an electron transport layer and an electron injection layer, and at least either one of the electron transport layer and the electron injection layer contains an electron-donating material.

The present invention provides an organic EL device having high light-emission efficiency and excellent in drive durability. More particularly, an improved organic EL device having low drive voltage and long drive durability is provided.

An organic EL device of the present invention is explained below in detail.

(Constitution)

The organic electroluminescence device according to the present invention has at least one organic compound layer including a light-emitting layer between a pair of electrodes (anode and cathode), and further preferably has a hole transport layer between the anode and the light-emitting layer as well as an electron transport layer between the cathode and the light-emitting layer.

In view of the nature of an organic electroluminescence device, it is preferred that at least either electrode of the pair of electrodes is transparent.

As a lamination pattern of the organic compound layer according to the present invention, it is preferred that the layer includes a hole transport layer, a light-emitting layer, and electron transport layer in this order from the anode side. Moreover, a hole injection layer is provided between the hole transport layer and the anode and/or an electron transporting intermediate layer is provided between the light-emitting layer and the electron transport layer. In addition, a hole transporting intermediate layer may be provided between the light-emitting layer and the hole transport layer, and similarly, an electron injection layer may be provided between the cathode and the electron transport layer.

The preferred modes of the organic compound layer in the organic electroluminescence device of the present invention are as follows. (1) An embodiment having a hole injection layer, a hole transport layer (the hole injection layer may also have the role of the hole transport layer), a hole transporting intermediate layer, a light-emitting layer, an electron transport layer, and an electron injection layer (the electron transport layer may also have the role of the electron injection layer) in this order from the anode side; (2) an embodiment having a hole injection layer, a hole transport layer (the hole injection layer may also have the role of the hole transport layer), a light-emitting layer, an electron transporting immediate layer, an electron transport layer, and an electron injection layer (the electron transport layer may also have the role of the electron injection layer) in this order from the anode side; and (3) an embodiment having a hole injection layer, a hole transport layer (the hole injection layer may also have the role of the hole transport layer), a hole transporting intermediate layer, a light-emitting layer, an electron transporting intermediate layer, an electron transport layer, and an electron injection layer (the electron transport layer may also have the role of the electron injection layer) in this order from the anode side.

The above-described hole transporting intermediate layer preferably has at least either a function for accelerating the injection of holes into the light-emitting layer, or a function for blocking electrons.

Furthermore, the above-described electron transporting intermediate layer preferably has at least either a function for accelerating the injection of electrons into the light-emitting layer, or a function for blocking holes.

Moreover, at least either of the above-described hole transporting intermediate layer and the electron transporting intermediate layer preferably has a function for blocking excitons produced in the light-emitting layer.

In order to realize effectively the functions for accelerating the injection of holes, or the injection of electrons, and the functions for blocking holes, electrons, or excitons, it is preferred that the hole transporting intermediate layer and the electron transporting intermediate layer are adjacent to the light-emitting layer.

The respective layers mentioned above may be separated into a plurality of secondary layers.

Next, the components constituting the organic electroluminescence device of the present invention will be described in detail.

The organic electroluminescence device of the present invention has at least one organic compound layer including a light-emitting layer. Examples of layers included in the organic compound layers other than the light-emitting layer include, as mentioned above, respective layers of a hole injection layer, a hole transport layer, a hole transporting intermediate layer, a light-emitting layer, an electron transporting intermediate layer, an electron transport layer, an electron injection layer and the like.

The respective layers constituting the organic compound layer can be suitably formed in accordance with any of a dry film-forming method such as a vapor deposition method or a sputtering method; a transfer method; a printing method; a coating method; an ink-jet printing method; or a spray method.

(Light-Emitting Layer)

The light-emitting layer is a layer having functions of receiving a hole from an anode, a hole injection layer, a hole transport layer or a hole-transport intermediate layer, receiving an electron from a cathode, an electron injection layer, an electron transport layer or an electron-transport intermediate layer, and providing a site for hole-electron recombination to cause a light emission.

The organic electroluminescence device of the present invention includes a light-emitting layer containing at least a light-emitting material and an electrically inactive material having an energy difference (Eg) between a highest occupied molecular orbital and a lowest unoccupied molecular orbital of 4.0 eV or larger, wherein the light-emitting material contains at least a first light-emitting material and a second light-emitting material, the first light-emitting material is an electron-transport light-emitting material, the second light-emitting material is a hole-transport light-emitting material, and the light-emitting layer has a thickness of from 0.5 nm to 20 nm.

The light-emitting layer may be formed by a single layer or by two or more layers, and the layers may emit lights with respectively different colors. In the case where the light-emitting layer is constituted of plural layers, at least one layer thereof contains the electrically inactive material, the first light-emitting material and the second light-emitting material.

Preferably, an electron affinity (Ea1) of the first light-emitting material is larger than an electron affinity (Ea2) of the second light-emitting material, and an ionization potential (Ip1) of the first light-emitting material is larger than an ionization potential (Ip2) of the second light-emitting material. More preferably, Ea1 is larger, by 0.01 eV or more, than Ea2, and further preferably larger by 0.02 eV or more. Also, more preferably, Ip1 is larger, by 0.01 eV or more, than Ip2, and further preferably larger by 0.02 eV or more.

The content proportions of the inactive material, the first light-emitting material and the second light-emitting material in the light-emitting layer of the invention are variable depending on the specific structures of the respective materials, but are selected within a range so as to maintain an appropriate carrier mobility in the light-emitting layer and maintain a balance between the hole mobility and the electron mobility. In general, however, the total amount of the light-emitting materials, including the first light-emitting material and the second light-emitting material, is preferably within a mass ratio range of from 5% to 40% with respect to the amount of the inactive material. More preferably the mass ratio is from 5% to 35%.

The content proportions of the first light-emitting material and the second light-emitting material are variable depending on the specific structures of the respective materials, but are selected within a range so as to maintain a balance between the hole mobility and the electron mobility. In general, however, the ratio of the first light-emitting material with respect to the second light-emitting material is preferably within a mass ratio range of from 30% to 70% and, more preferably within a mass ratio range of from 40% to 60%.

The thickness of the light-emitting layer is from 0.5 nm to 20 nm, preferably from 1 nm to 15 nm, and more preferably from 1 nm to 10 mn. A thickness of the light-emitting layer of less than 0.5 nm is undesirable in view of deterioration of the light-emitting efficiency and the durability, and a thickness exceeding 20 nm is undesirable because of an increase in the drive voltage.

1) Inactive Material

The light-emitting layer of the present invention comprises an electrically inactive material having an energy difference (Eg) between a highest occupied molecular orbital and a lowest unoccupied molecular orbital of 4.0 eV or larger.

The Eg is preferably 4.1 eV to 5.0 eV, and more preferably 4.2 eV to 5.0 eV. In the case the Eg is less than 4.0 eV, holes or electrons are trapped by the inactive material, and therefore an adequate carrier mobility can not be maintained, resulting in an inferior light emission efficiency and a degradation in drive durability.

In the present invention, an electrically inactive material having an energy difference between a highest occupied molecular orbital and a lowest unoccupied molecular orbital of 4.0 eV or larger can be selected from organic compounds or inorganic compounds.

An electrically inactive material selected from organic compounds is preferably a compound which has an ionization potential (Ip) larger than an ionization potential of the first light-emitting material. More preferably, the Ip of the electrically inactive material is larger than an ionization potential of the first light-emitting material by 0.1 eV or more, and even more preferably larger by 0.2 eV or more.

Further, it is preferred that an electron affinity (Ea) of the electrically inactive material is smaller than that of the second light-emitting material. More preferably, the Ea of the electrically inactive material is smaller than that of the second light-emitting material by 0.1 eV or more, and even more preferably smaller by 0.2 eV or more.

Preferably, specific examples of the electrically inactive material are selected from aromatic hydrocarbon compounds. One group thereof is compounds represented by the following formula (1).

L-(Ar)ₘ Formula (1)

In the formula (1), Ar represents a group represented by the following formula (2), L represents a benzene skeleton having a valence of 3 or more, and m represents an integer of 3 or more.

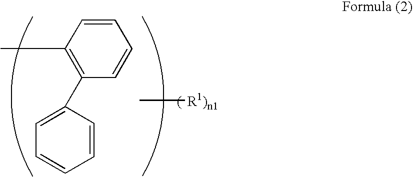

In formula (2), R¹ represents a substituent, with a proviso that, in the presence of plural R¹s, R¹s may be the same or different from each other, and n1 represents an integer from 0 to 9.

Another preferable embodiment of the aromatic hydrocarbon compound is a compound represented by the following formula (3).

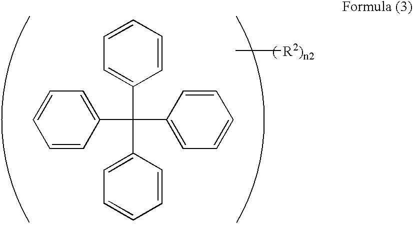

In formula (3), R² represents a substituent, with a proviso that, in the presence of plural R²s, R²s may be the same or different from each other, and n2 represents an integer from 0 to 20.

Formula (1) will be described below in detail.

L in formula (1) represents a benzene skeleton having a valency of 3 or more. Ar represents a group represented by formula (2); and m represents an integer of 3 or more. m is preferably from 3 to 6, and more preferably 3 or 4.

Next, the group represented by formula (2) will be described below.

R¹ in formula (2) represents a substituent. Examples of the substituent include an alkyl group (preferably having from 1 to 30 carbon atoms, more preferably from 1 to 20 carbon atoms, and especially preferably from 1 to 10 carbon atoms; for example, methyl, ethyl, isopropyl, tert-butyl, n-octyl, n-decyl, n-hexadecyl, cyclopropyl, cyclopentyl, and cyclohexyl), an alkenyl group (preferably having from 2 to 30 carbon atoms, more preferably from 2 to 20 carbon atoms, and especially preferably from 2 to 10 carbon atoms; for example, vinyl, allyl, 2-butenyl, and 3-pentenyl), an alkynyl group (preferably having from 2 to 30 carbon atoms, more preferably from 2 to 20 carbon atoms, and especially preferably from 2 to 10 carbon atoms; for example, propargyl and 3-pentynyl), an aryl group (preferably having from 6 to 30 carbon atoms, more preferably from 6 to 20 carbon atoms, and especially preferably from 6 to 12 carbon atoms; for example, phenyl, p-methylphenyl, naphthyl, and anthranyl), an amino group (preferably having from 0 to 30 carbon atoms, more preferably from 0 to 20 carbon atoms, and especially preferably from 0 to 10 carbon atoms; for example, amino, methylamino, dimethylamino, diethylamino, dibenzylamino, diphenylamino, and ditolylamino), an alkoxy group (preferably having from 1 to 30 carbon atoms, more preferably from 1 to 20 carbon atoms, and especially preferably from 1 to 10 carbon atoms; for example, methoxy, ethoxy, butoxy, and 2-ethylhexyloxy), an aryloxy group (preferably having from 6 to 30 carbon atoms, more preferably from 6 to 20 carbon atoms, and especially preferably from 6 to 12 carbon atoms; for example, phenyloxy, 1-naphthyloxy, and 2-naphthyloxy), a heteroaryloxy group (preferably having from 1 to 30 carbon atoms, more preferably from 1 to 20 carbon atoms, and especially preferably from 1 to 12 carbon atoms; for example, pyridyloxy, pyrazyloxy, pyrimidyloxy, and quinolyloxy), an acyl group (preferably having from 1 to 30 carbon atoms, more preferably from 1 to 20 carbon atoms, and especially preferably from 1 to 12 carbon atoms; for example, acetyl, benzoyl, formyl, and pivaloyl), an alkoxycarbonyl group preferably having from 2 to 30 carbon atoms, more preferably from 2 to 20 carbon atoms, and especially preferably from 2 to 12 carbon atoms; for example, methoxycarbonyl and ethoxycarbonyl), an aryloxycarbonyl group (preferably having from 7 to 30 carbon atoms, more preferably from 7 to 20 carbon atoms, and especially preferably from 7 to 12 carbon atoms; for example, phenyloxycarbonyl), an acyloxy group (preferably having from 2 to 30 carbon atoms, more preferably from 2 to 20 carbon atoms, and especially preferably from 2 to 10 carbon atoms; for example, acetoxy and benzoyloxy), an acylamino group preferably having from 2 to 30 carbon atoms, more preferably from 2 to 20 carbon atoms, and especially preferably from 2 to 10 carbon atoms; for example, acetylamino and benzoylamino), an alkoxycarbonylamino group (preferably having from 2 to 30 carbon atoms, more preferably from 2 to 20 carbon atoms, and especially preferably from 2 to 12 carbon atoms; for example, methoxycarbonylamino), an aryloxycarbonylamino group preferably having from 7 to 30 carbon atoms, more preferably from 7 to 20 carbon atoms, and especially preferably from 7 to 12 carbon atoms; for example, phenyloxycarbonylamino), a sulfonylamino group (preferably having from 1 to 30 carbon atoms, more preferably from 1 to 20 carbon atoms, and especially preferably from 1 to 12 carbon atoms; for example, methanesulfonylamino and benzenesulfonylamino), a sulfamoyl group (preferably having from 0 to 30 carbon atoms, more preferably from 0 to 20 carbon atoms, and especially preferably from 0 to 12 carbon atoms; for example, sulfamoyl, methylsulfamoyl, dimethylsulfamoyl, and phenylsulfamoyl), a carbamoyl group (preferably having from 1 to 30 carbon atoms, more preferably from 1 to 20 carbon atoms, and especially preferably from 1 to 12 carbon atoms; for example, carbamoyl, methylcarbamoyl, diethylcarbamoyl, and phenylcarbamoyl), an alkylthio group (preferably having from 1 to 30 carbon atoms, more preferably from 1 to 20 carbon atoms, and especially preferably from 1 to 12 carbon atoms; for example, methylthio and ethylthio); an arylthio group (preferably having from 6 to 30 carbon atoms, more preferably from 6 to 20 carbon atoms, and especially preferably from 6 to 12 carbon atoms; for example, phenylthio), a heteroarylthio group (preferably having from 1 to 30 carbon atoms, more preferably from 1 to 20 carbon atoms, and especially preferably from 1 to 12 carbon atoms; for example, pyridylthio, 2-benzimidazolylthio, 2-benzoxazolylthio, and 2-benzthiazolylthio), a sulfonyl group (preferably having from 1 to 30 carbon atoms, more preferably from 1 to 20 carbon atoms, and especially preferably from 1 to 12 carbon atoms; for example, mesyl and tosyl), a sulfinyl group (preferably having from 1 to 30 carbon atoms, more preferably from 1 to 20 carbon atoms, and especially preferably from 1 to 12 carbon atoms; for example, methanesulfinyl and benzenesulfinyl), a ureido group (preferably having from 1 to 30 carbon atoms, more preferably from 1 to 20 carbon atoms, and especially preferably from 1 to 12 carbon atoms; for example, ureido, methylureido, and phenylureido), a phosphoric amido group (preferably having from 1 to 30 carbon atoms, more preferably from 1 to 20 carbon atoms, and especially preferably from 1 to 12 carbon atoms; for example, diethylphosphoric amido and phenylphosphoric amido), a hydroxy group, a mercapto group, a halogen atom (for example, a fluorine atom, a chlorine atom, a bromine atom, and an iodine atom), a cyano group, a sulfo group, a carboxy group, a nitro group, a hydroxamic acid group, a sulfino group, a hydrazino group, an imino group, a heterocyclic group (preferably having from 1 to 30 carbon atoms, and more preferably from 1 to 12 carbon atoms; examples of the hetero atom include a nitrogen atom, an oxygen atom, and a sulfur atom; and specific examples thereof include imidazolyl, pyridyl, quinolyl, furyl, thienyl, piperidyl, morpholino, benzoxazolyl, benzimidazolyl, benzthiazolyl, carbazolyl and azepinyl), and a silyl group (preferably having from 3 to 40 carbon atoms, more preferably from 3 to 30 carbon atoms, and especially preferably from 3 to 24 carbon atoms; for example, trimethylsilyl and triphenylsilyl).

When plural R¹s are present, they may be the same or different and may bond to each other to form a ring Also, R¹ may further be substituted.

n1 represents an integer of from 0 to 9. n1 is preferably an integer of from 0 to 6, and more preferably from 0 to 3.

Subsequently, formula (3) will be described below.

In formula (3), R² represents a substituent. The substituent R² is synonymous with the foregoing substituent R¹ including the preferred embodiment thereof.

n2 represents an integer of from 0 to 20. n2 is preferably in the range of from 0 to 10, and more preferably from 0 to 5.

Compound examples of formula (1) or formula (3) will be given below, but it should not be construed that the invention is limited thereto.

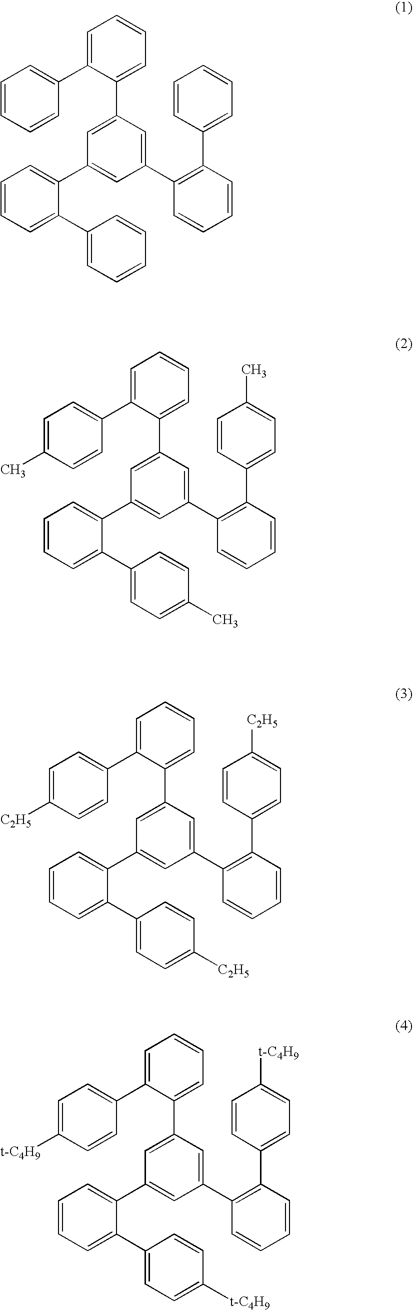

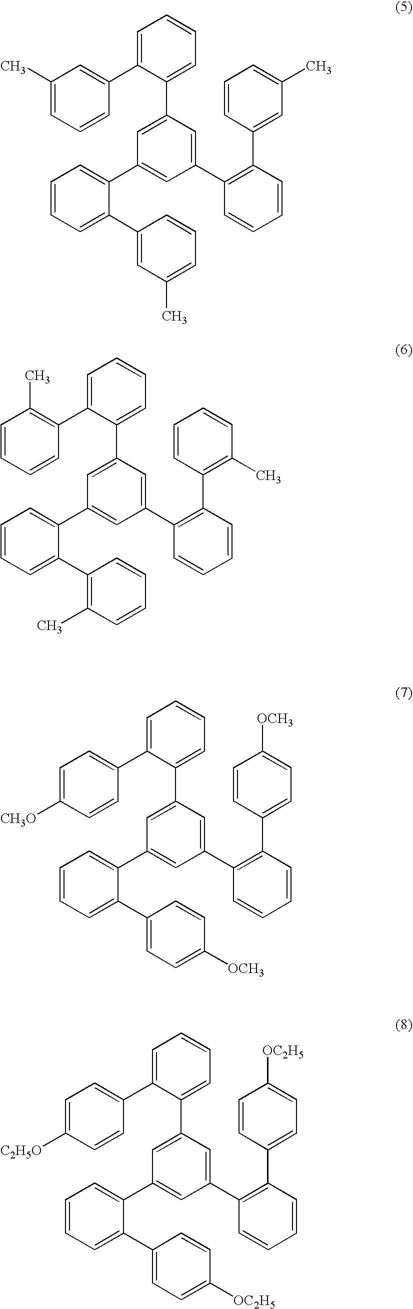

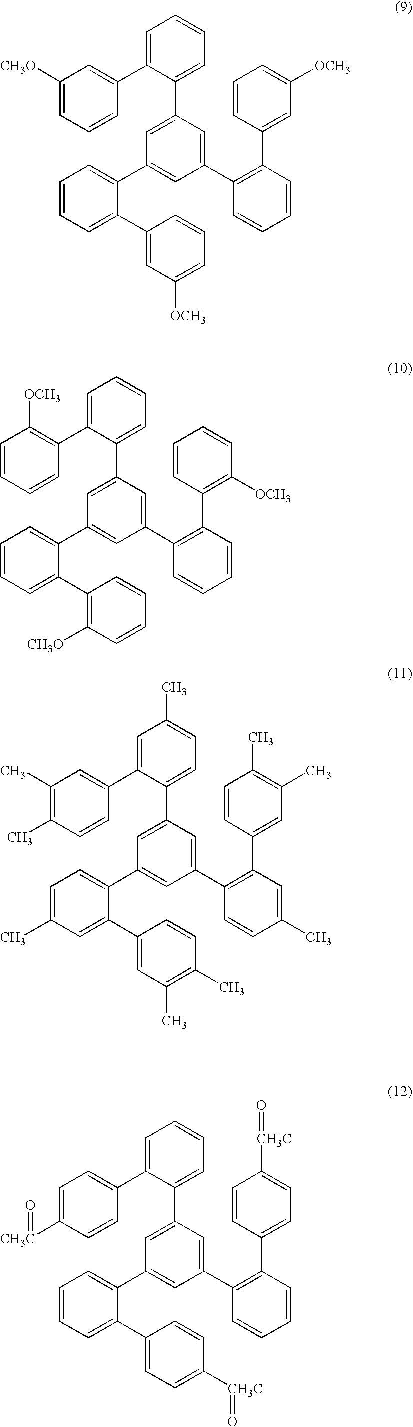

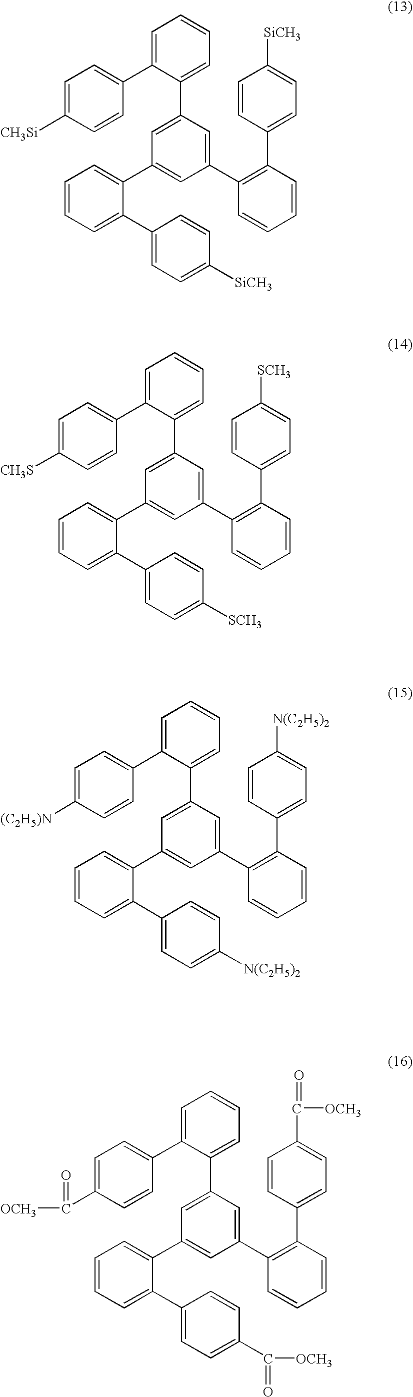

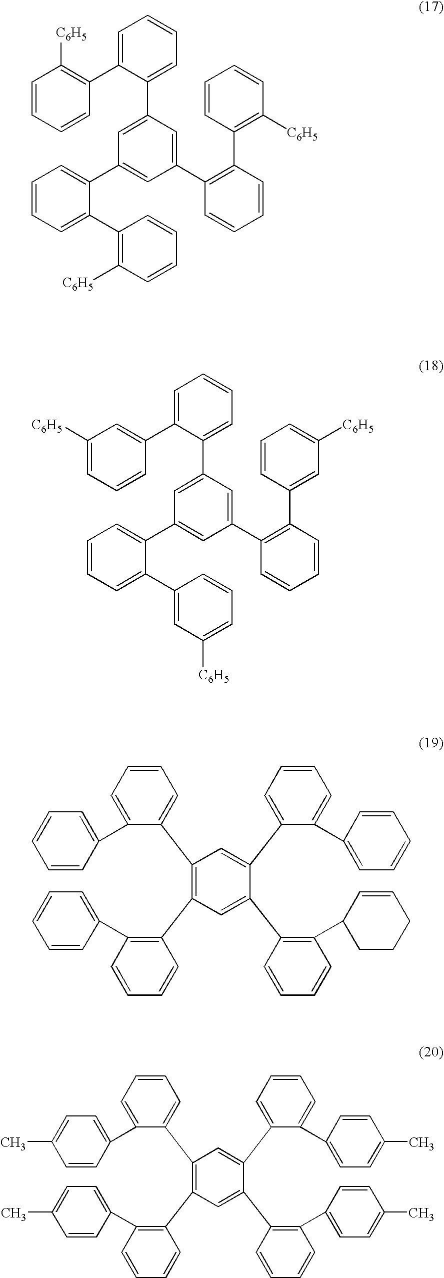

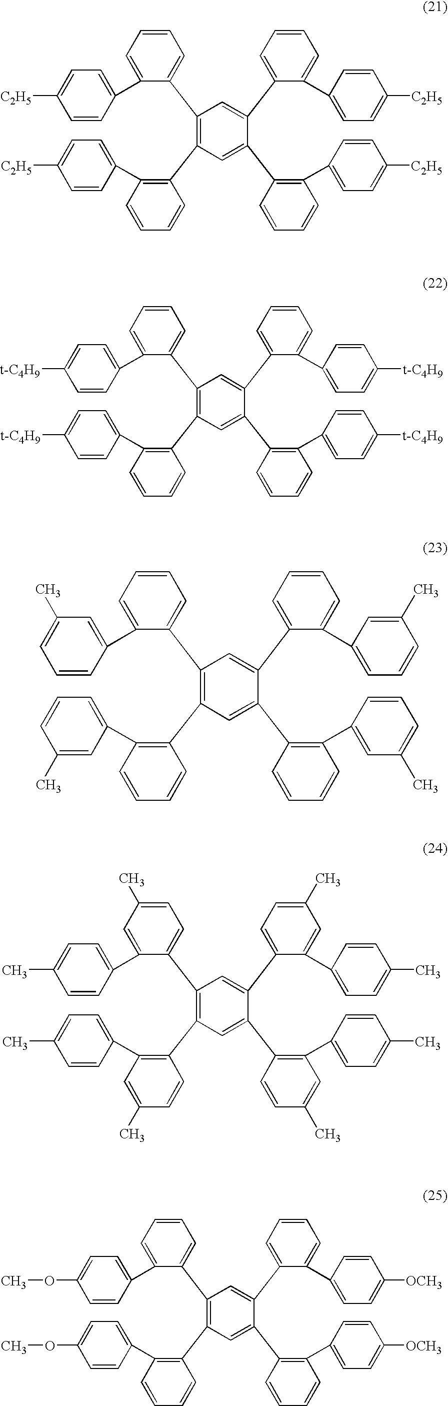

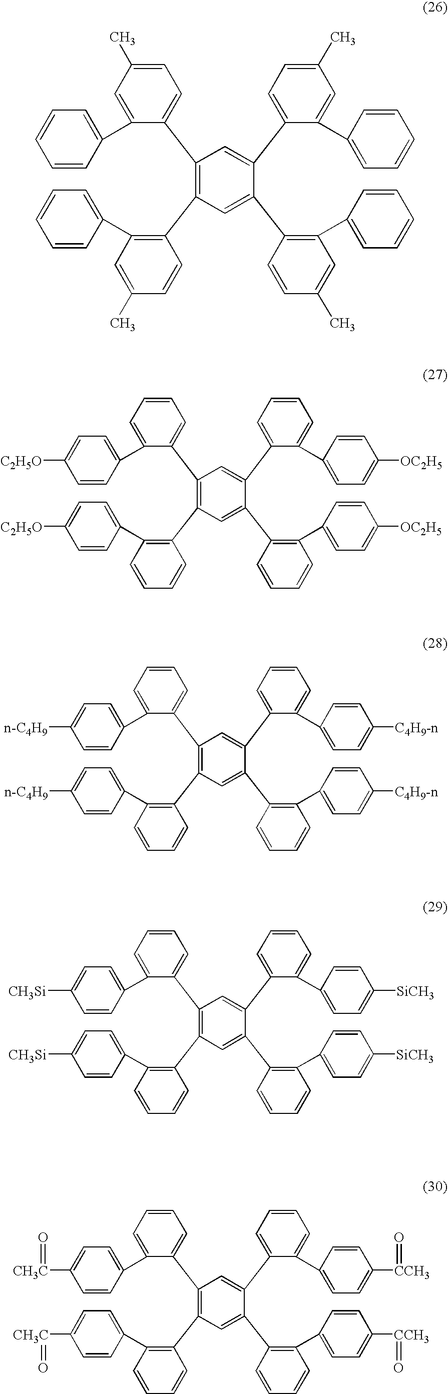

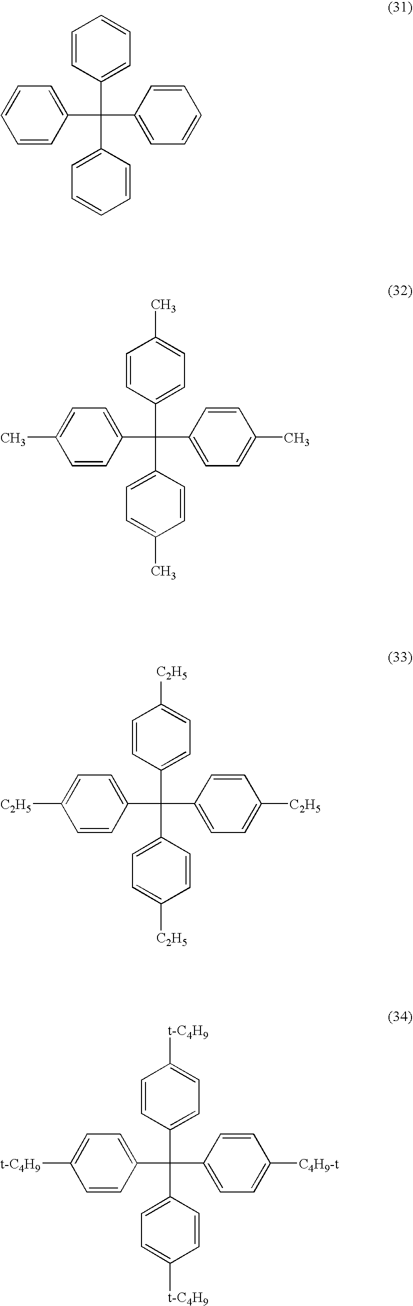

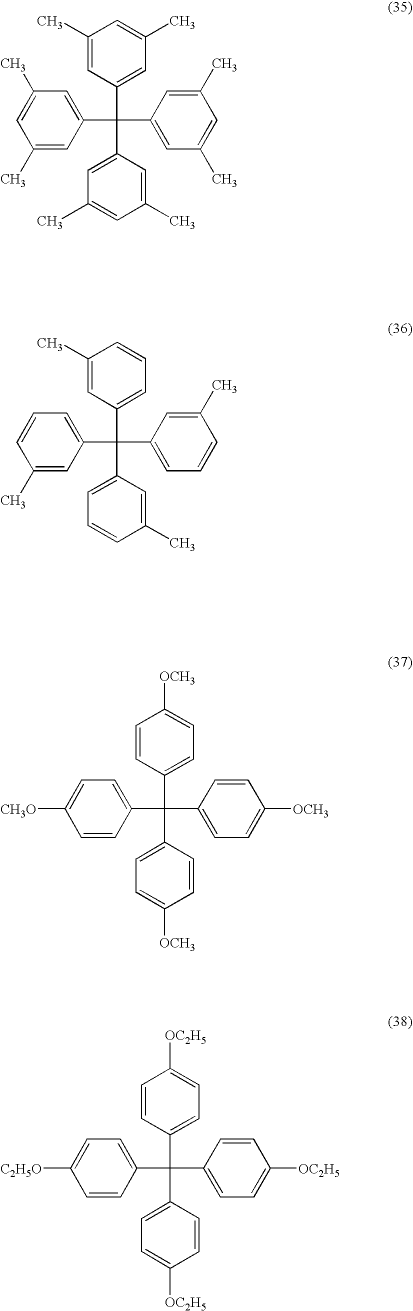

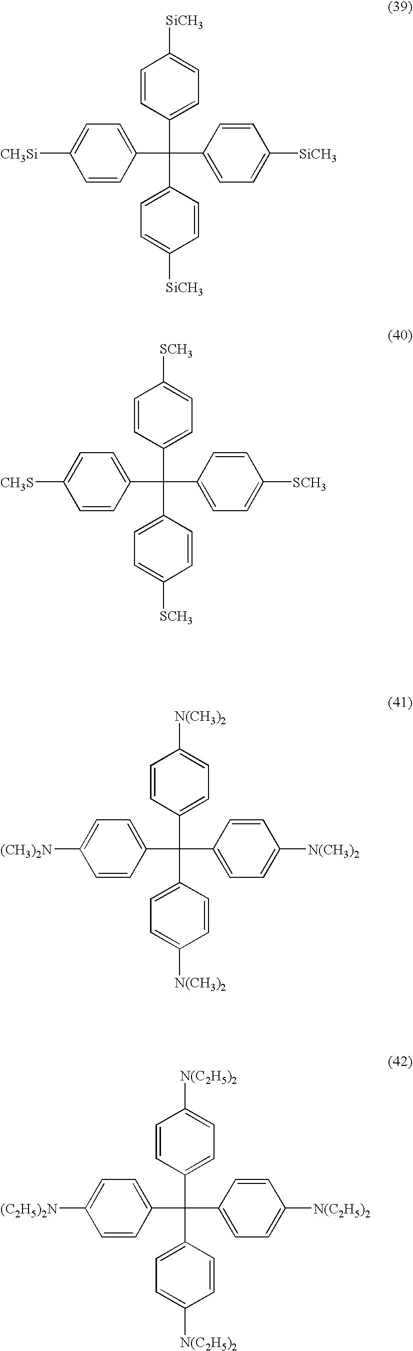

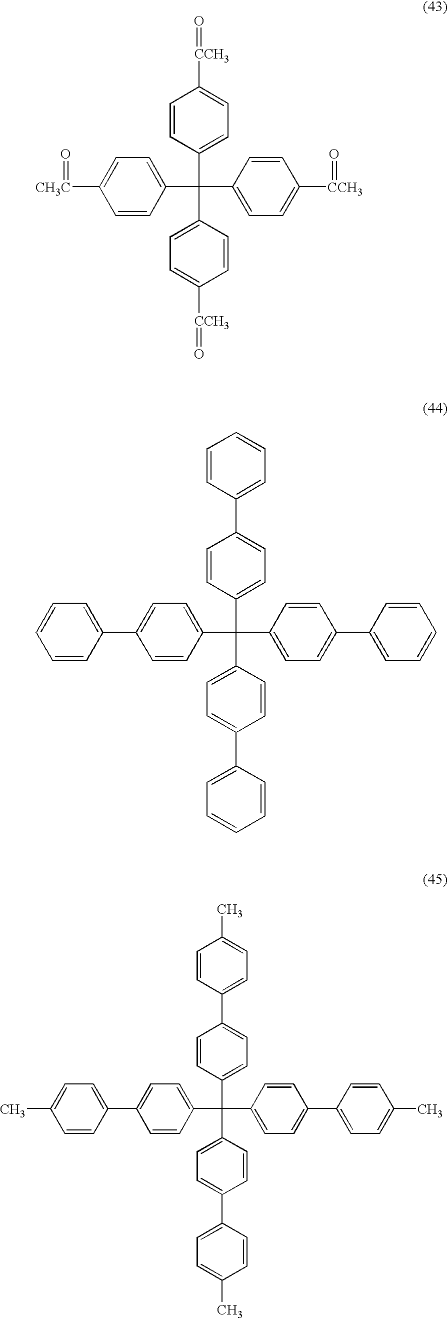

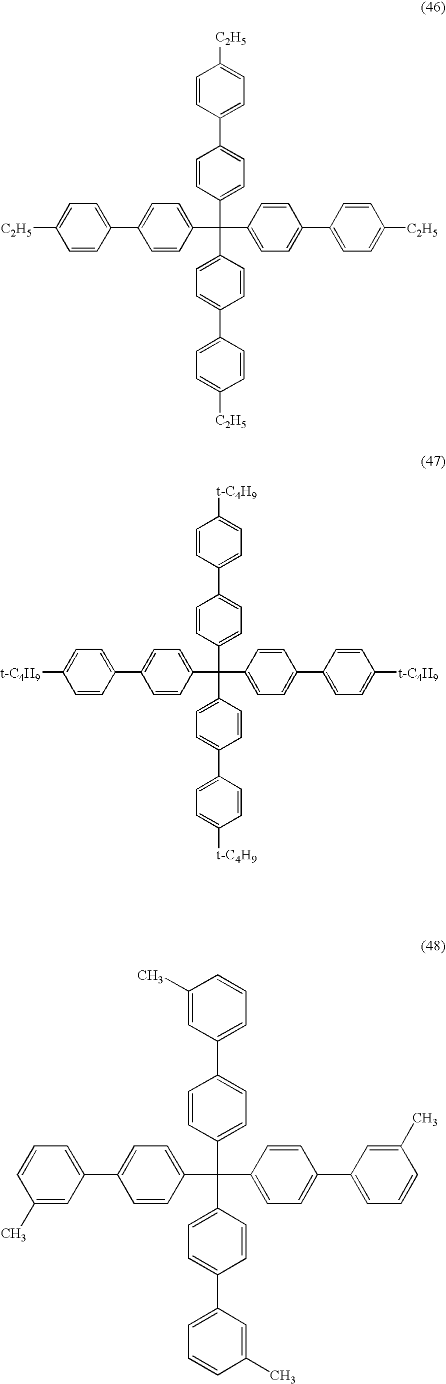

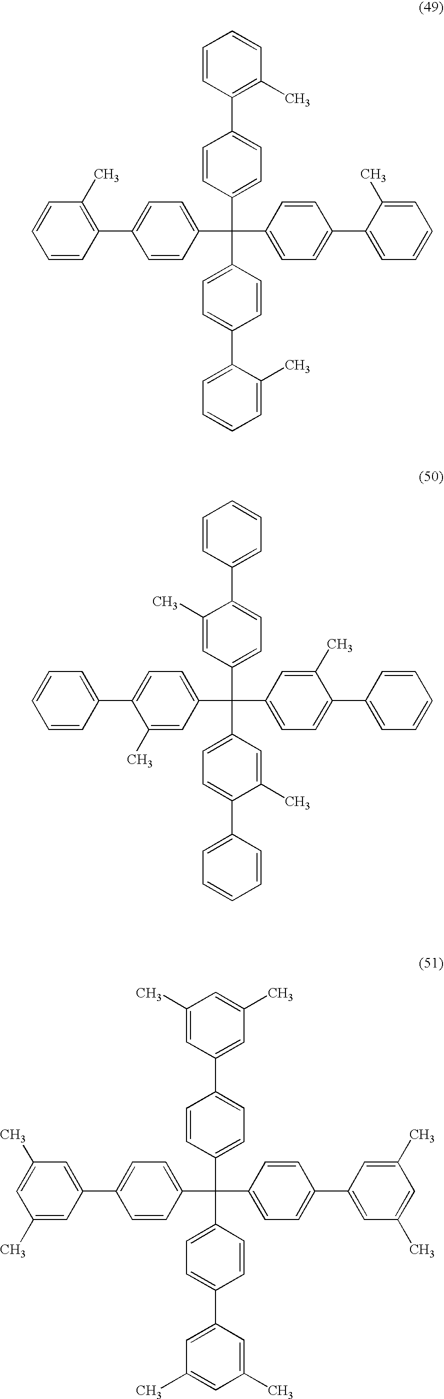

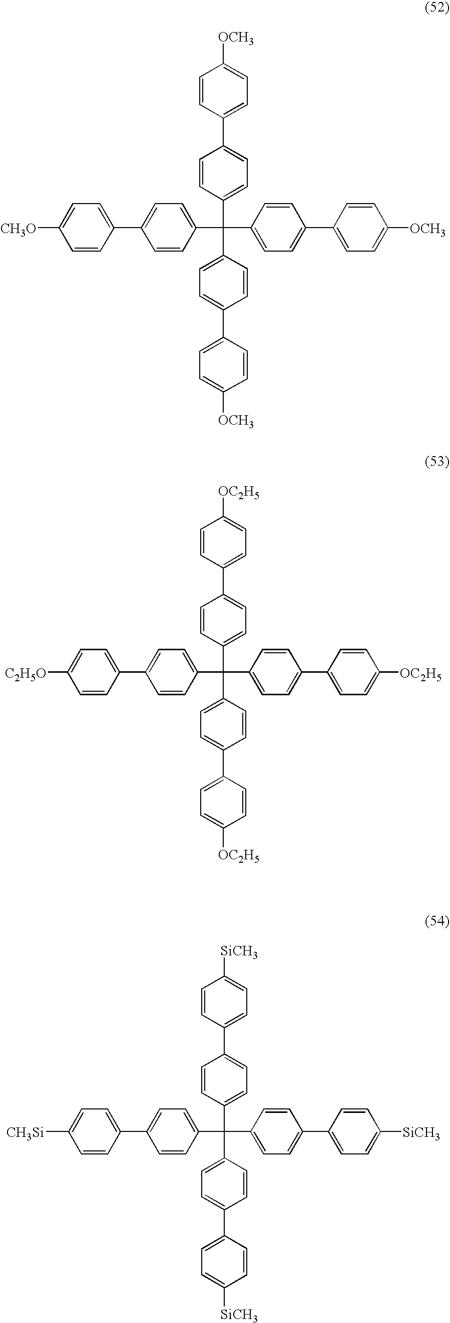

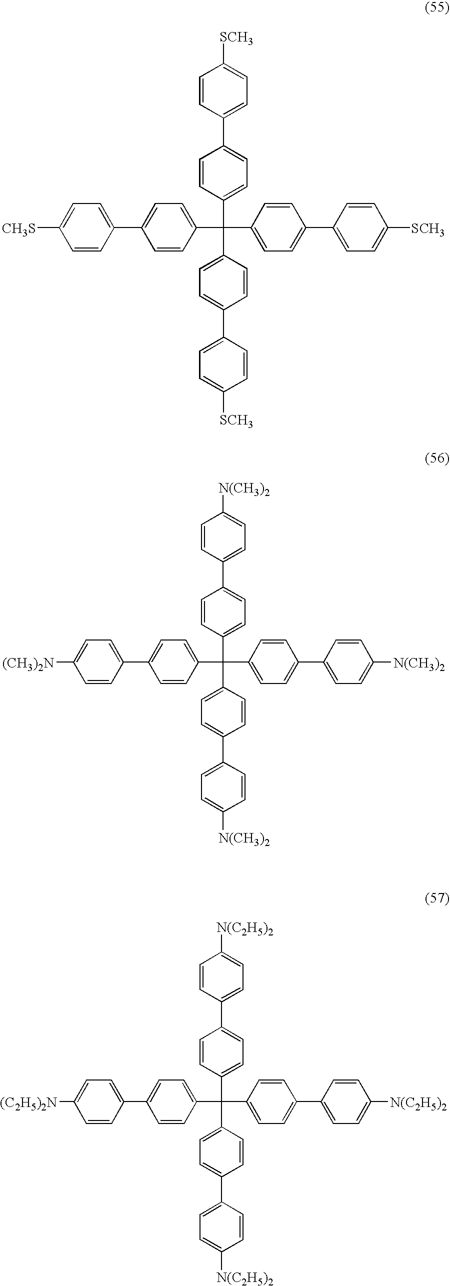

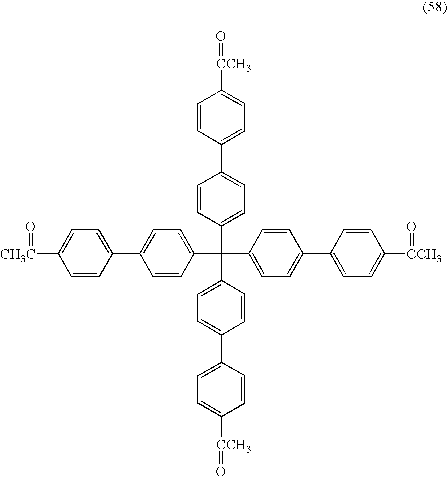

Another group of the electrically inactive material to be employed in the invention includes insulating inorganic compounds.

The insulating inorganic compound to be employed in the invention is not particularly restricted so far as it is an inorganic compound substantially lacking electrical conductivity. Examples of the usable compound include metal oxides, metal nitrides, metal carbides, metal halides, metal sulfates, metal nitrates, metal phosphates, metal sulfides, metal carbonates, metal borohalides and metal phosphohalides, among which preferable are, in consideration of the mutual solubility with the light-emitting material and the film forming property, silicon oxide, silicon dioxide, silicon nitride, silicon oxynitride, silicon carbide, germanium oxide, germanium dioxide, tin oxide, tin dioxide, barium oxide, lithium fluoride, lithium chloride, cesium fluoride, cesium chloride and the like, and more preferable are silicon nitride, silicon oxynitride, silicon oxide and silicon carbide.

2) First Light-Emitting Material

As a light-emitting material in the present invention, both of a phosphorescence light-emitting material and a fluorescence light-emitting material can be used. Preferably, a phosphorescence light-emitting material is used.

<<Phosphorescence Material>>

Examples of the phosphorescence light-emitting material are not limited specifically, but generally include complexes containing a transition metal atom or a lantanoid atom.

For instance, although the transition metal atom is not limited, it is preferably ruthenium, rhodium, palladium, tungsten, rhenium, osmium, iridium, or platinum; more preferably rhenium, iridium, or platinum, or even more preferably iridium, or platinum.

Examples of the lantanoid atom include lanthanum, cerium, praseodymium, neodymium, samarium, europium, gadolinium, terbium, dysprosium, holmium, erbium, thulium, ytterbium, and lutetium, and among these lantanoid atoms, neodymium, europium, and gadolinium are preferred.

Examples of ligands in the complex include the ligands described, for example, in “Comprehensive Coordination Chemistry” authored by G. Wilkinson et al., published by Pergamon Press Company in 1987; “Photochemistry and Photophysics of Coordination Compounds” authored by H. Yersin, published by Springer-Verlag Company in 1987; and “YUHKI KINZOKU KAGAKU—KISO TO OUYOU—(Metalorganic Chemistry—Fundamental and Application—)” authored by Akio Yamamoto, published by Shokabo Publishing Co., Ltd. in 1982.

Specific examples of the ligands include preferably halogen ligands (preferably chlorine ligands), aromatic carboxycyclic ligands (e.g., cyclopentadienyl anions, benzene anions, or naphthyl anions and the like), nitrogen-containing heterocyclic ligands (e.g., phenylpyridine, benzoquinoline, quinolinol, bipyridyl, or phenanthroline and the like), diketone ligands (e.g., acetylacetone and the like), carboxylic acid ligands (e.g., acetic acid ligands and the like), alcoholate ligands (e.g., phenolate ligands and the like), carbon monoxide ligands, isonitryl ligands, and cyano ligand, and more preferably nitrogen-containing heterocyclic ligands.

The above-described complexes may be either a complex containing one transition metal atom in the compound, or a so-called polynuclear complex containing two or more transition metal atoms wherein different metal atoms may be contained at the same time.

Among these, specific examples of the light-emitting material include phosphorescence luminescent compounds described in patent documents such as U.S. Pat. No. 6,303,238B1, U.S. Pat. No. 6,097,147, WO00/57676, WO00/70655, WO01/08230, WO01/39234A2, WO01/41512A1, WO02/02714A2, WO02/15645A1, WO02/44189A1, JP-A No. 2001-247859, Japanese Patent Application No. 2000-33561, JP-A Nos. 2002-117978, 2002-225352, and 2002-235076, Japanese Patent Application No. 2001-239281, JP-A No. 2002-170684, EP1211257, JP-A Nos. 2002-226495, 2002-234894, 2001-247859, 2001-298470, 2002-173674, 2002-203678, 2002-203679, 2004-357791, 2006-256999, 2007-19462, etc.

<<Fluorescence Light-Emitting Material>>

Examples of the above-described fluorescent light-emitting material generally include, for example, benzoxazole derivatives, benzimidazoles derivatives, benzothiazole derivatives, styrylbenzene derivatives, polyphenyl derivatives, diphenylbutadiene derivatives, tetraphenylbutadiene derivatives, naphthylamide derivatives, coumalin derivatives, pyrane derivatives, perinone derivatives, oxadiazole derivatives, aldazine derivatives, pyralidine derivatives, cyclopentadiene derivatives, bis-styrylanthracene derivatives, quinacridone derivatives, pyrrolopyridine derivatives, thiadiazolopyridine derivatives, cyclopentadiene derivatives, styrylamine derivatives, aromatic dimethylidene compounds, condensed polycyclic aromatic compounds (for example, anthracene, phenanthroline, pyrene, perylene, rubrene, pentacene, or the like), a variety of metal complexes represented by metal complexes or rare-earth complexes of 8-quinolynol, polymer compounds such as polythiophene, polyphenylene and polyphenylenevinylene, organic silanes, and the like.

The first light-emitting material in the invention is an electron-transporting light-emitting material.

Preferably, the electron-transporting light-emitting material has an electron affinity (Ea) of from 2.5 eV to 3.5 eV, and an ionization potential (Ip) of from 5.7 eV to 7.0 eV.

As the first light-emitting material in the invention, an already known electron-transporting light-emitting material may be employed.

Preferable examples of the material include a complex of ruthenium, rhodium, palladium, tungsten, rhenium, osmium, iridium, platinum, lanthanum, cerium, praseodymium, neodymium, samarium, europium, gadolinium, terbium, dysprosium, holmium, erbium, thulium, ytterbium and lutetium; more preferably a complex of ruthenium, rhodium, palladium and platinum; and most preferably platinum complex.

Specific examples of platinum complex will be given below, but it should not be construed that the invention is limited thereto.

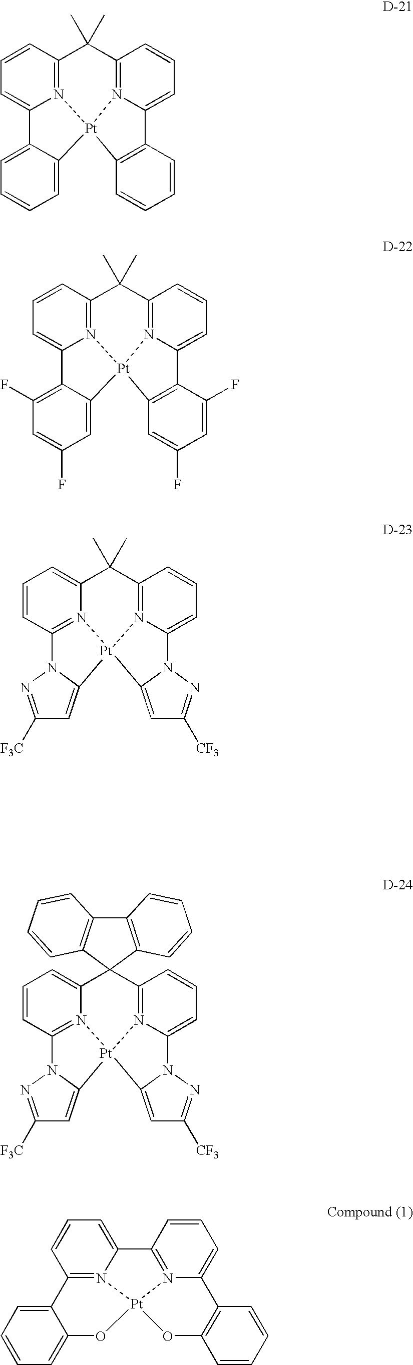

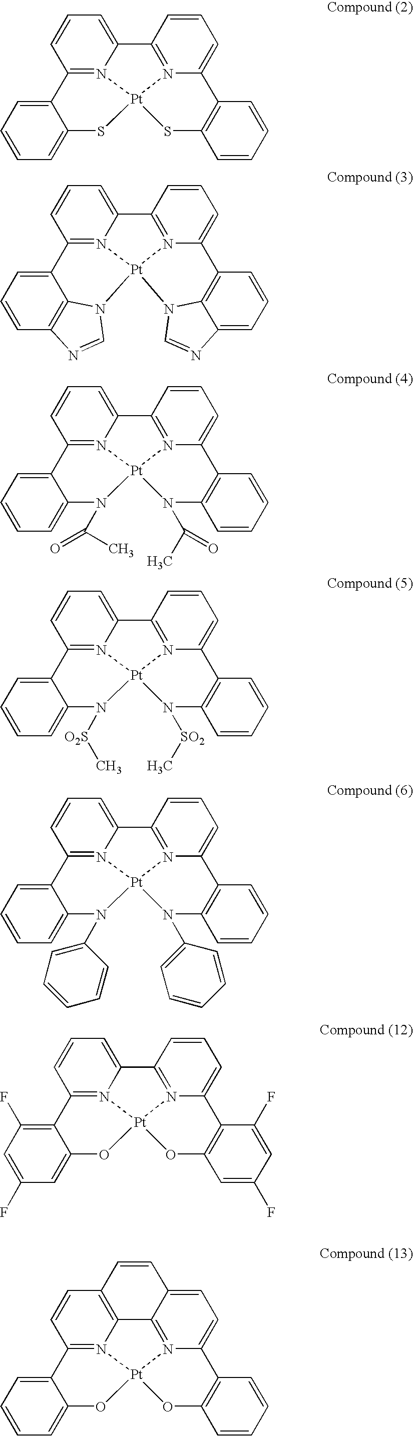

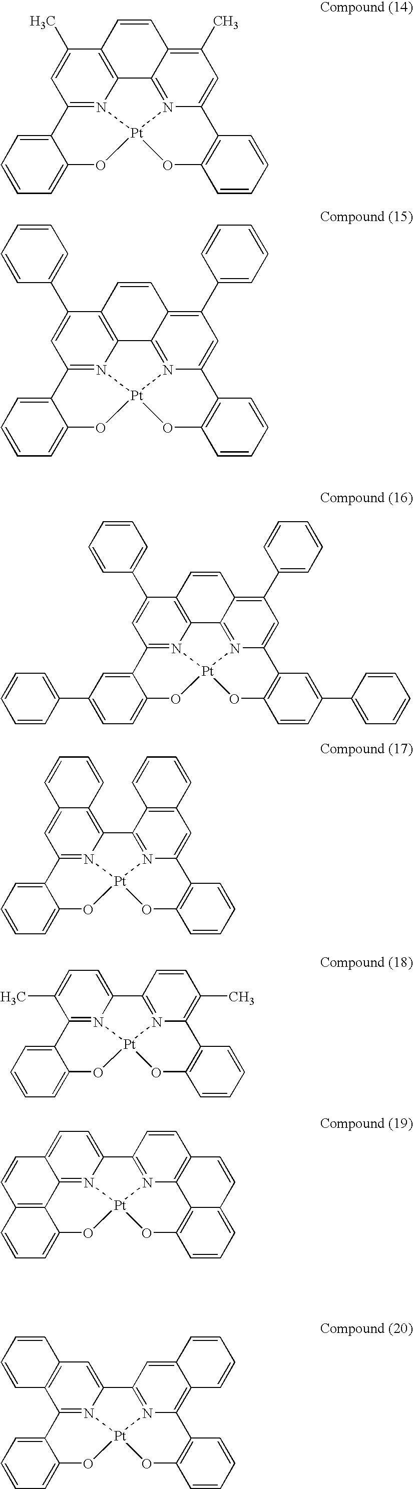

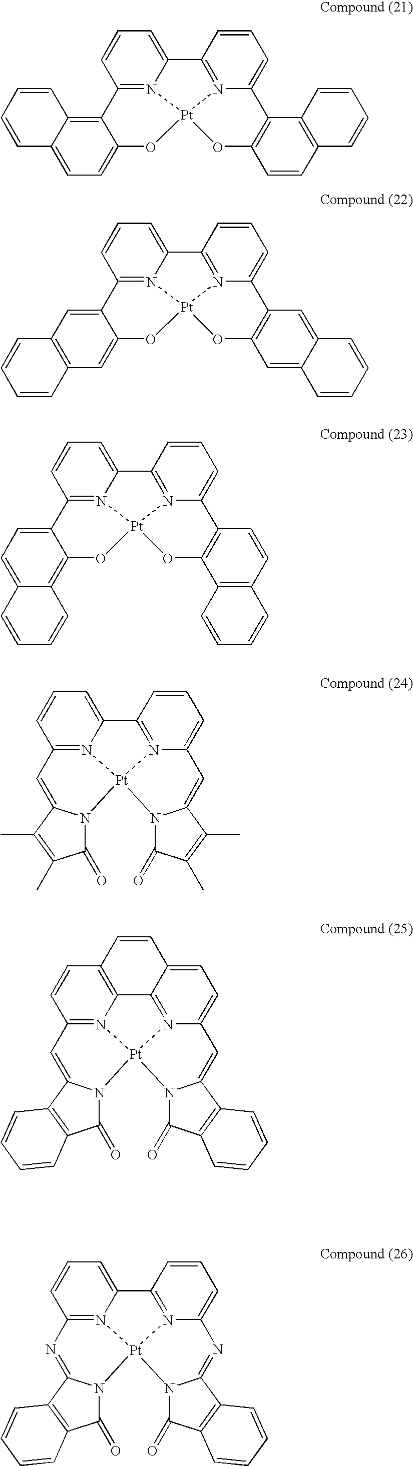

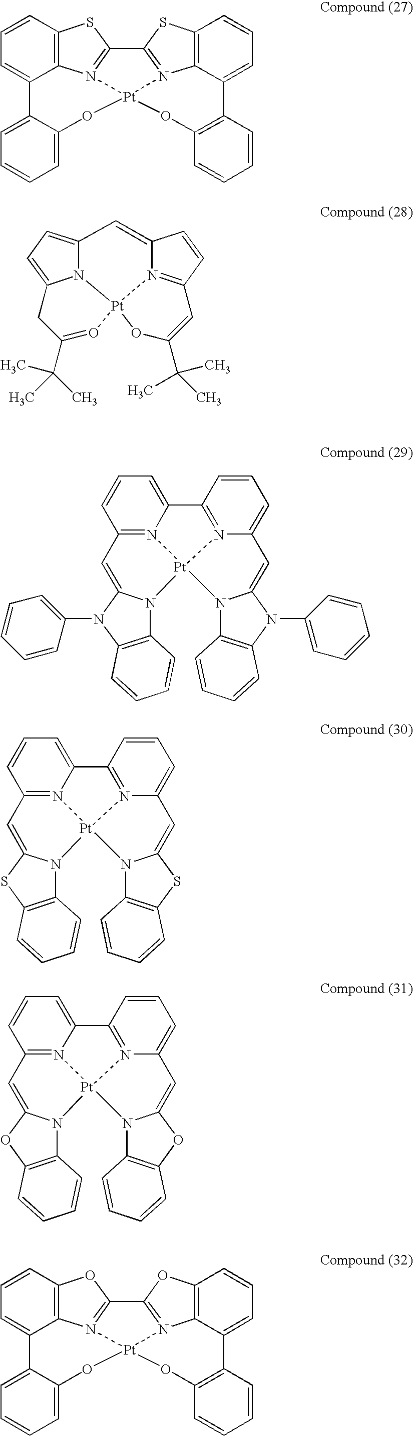

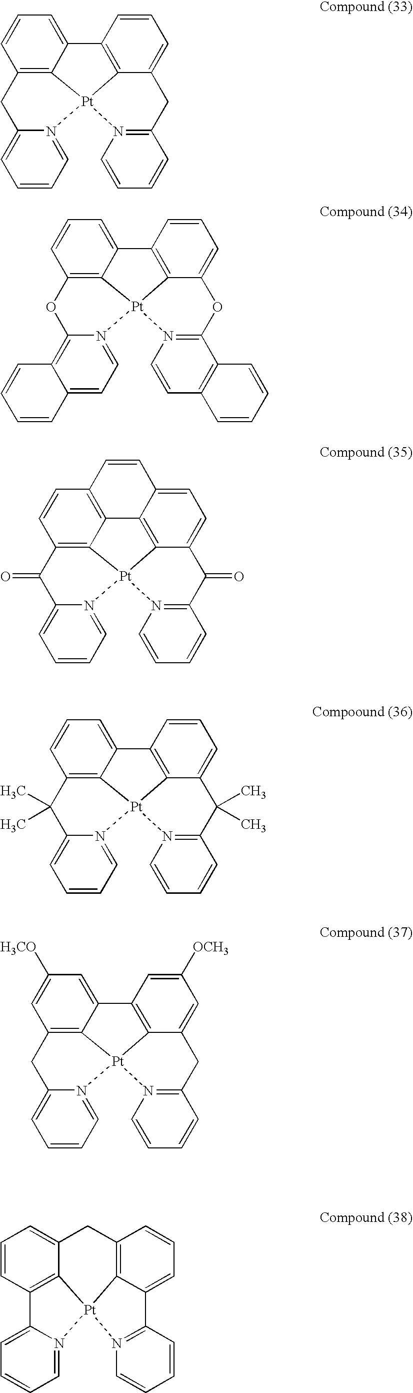

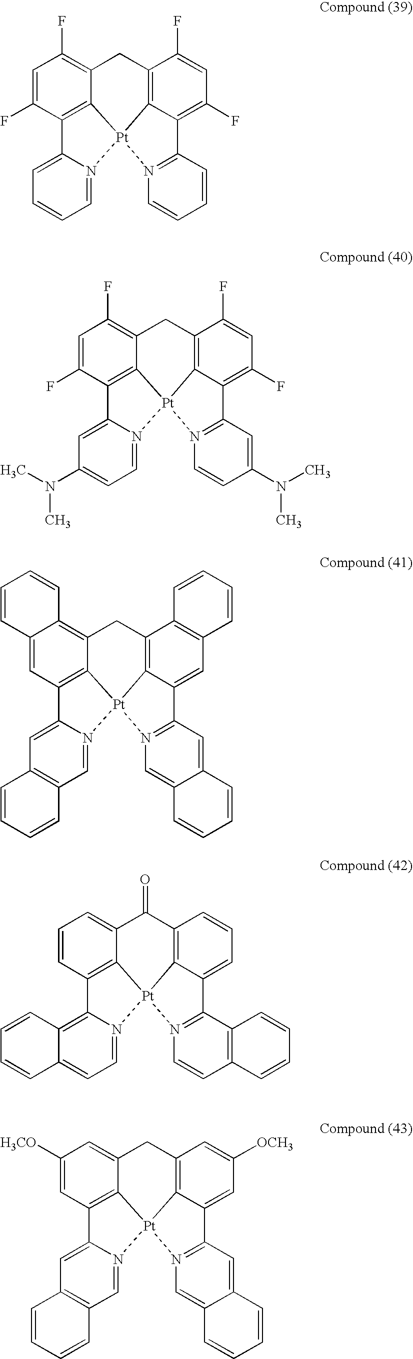

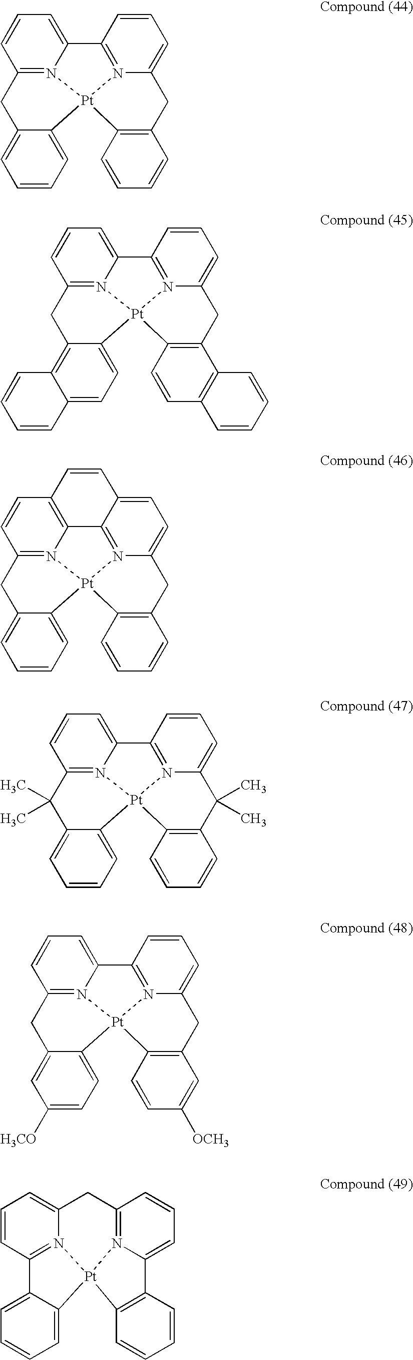

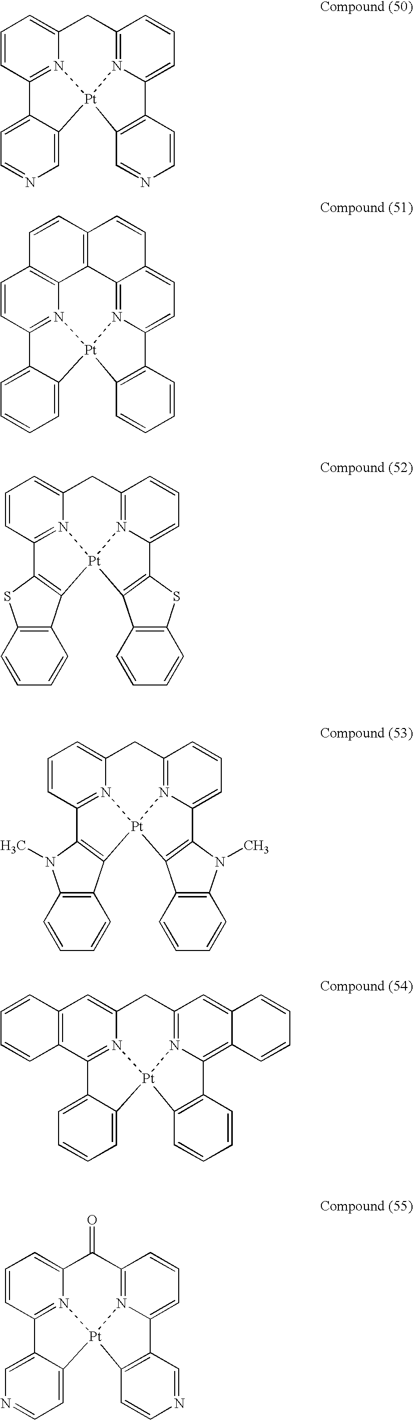

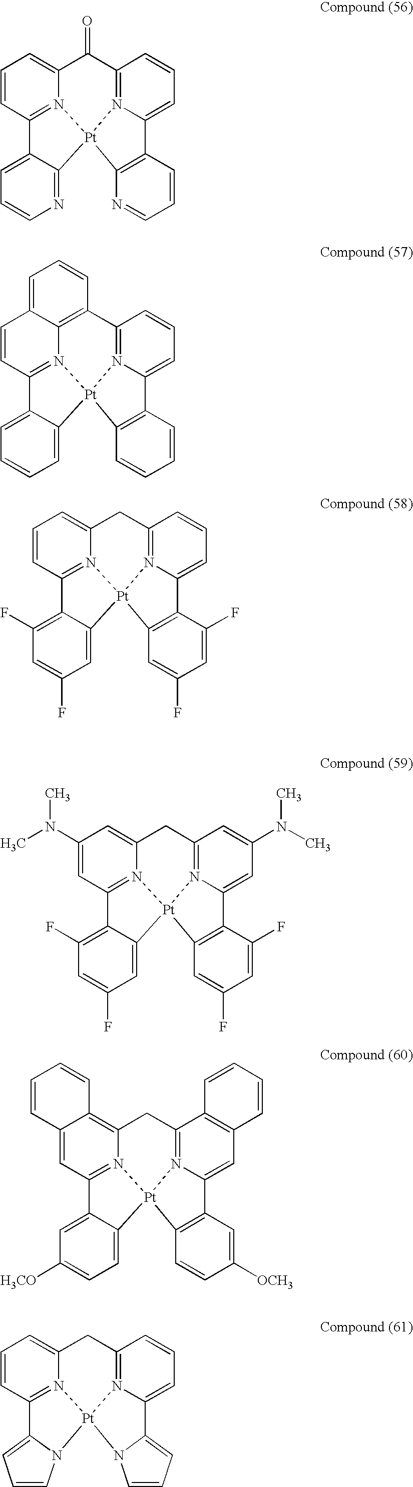

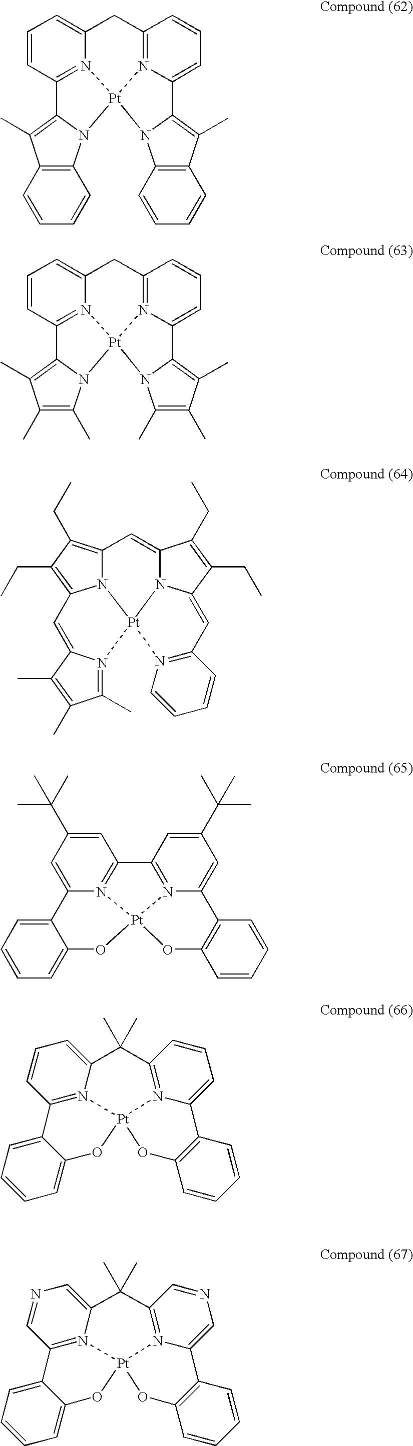

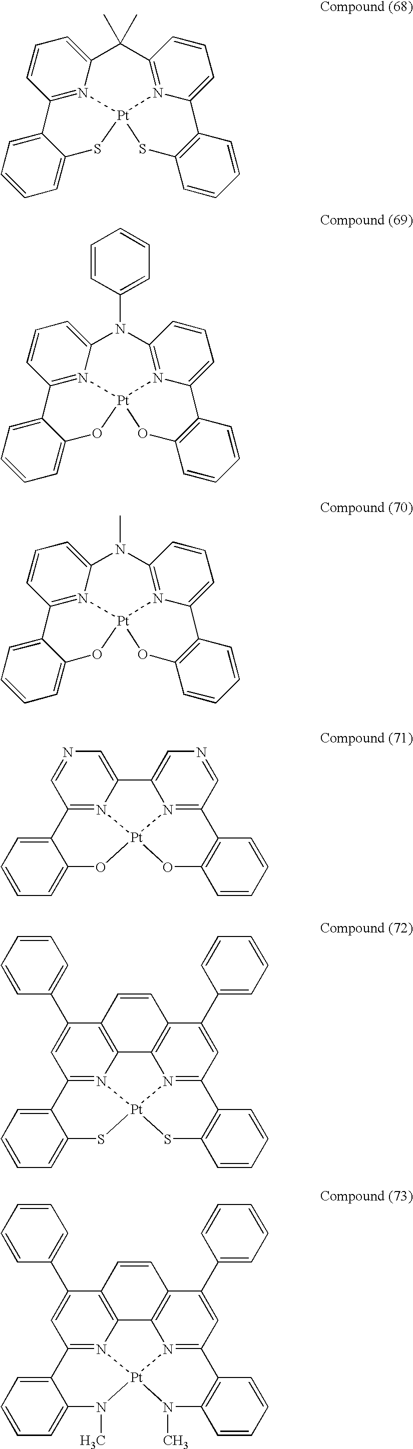

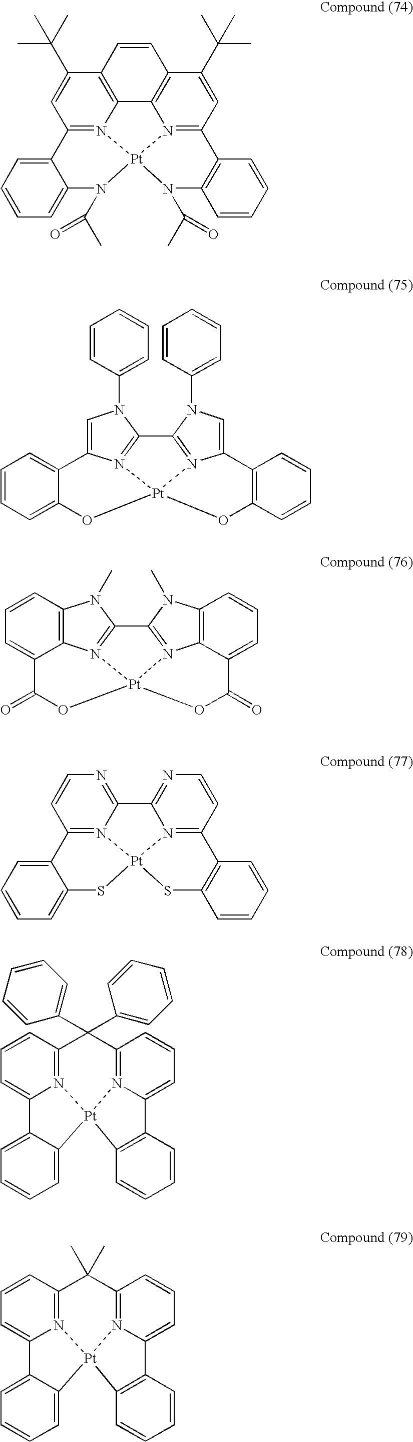

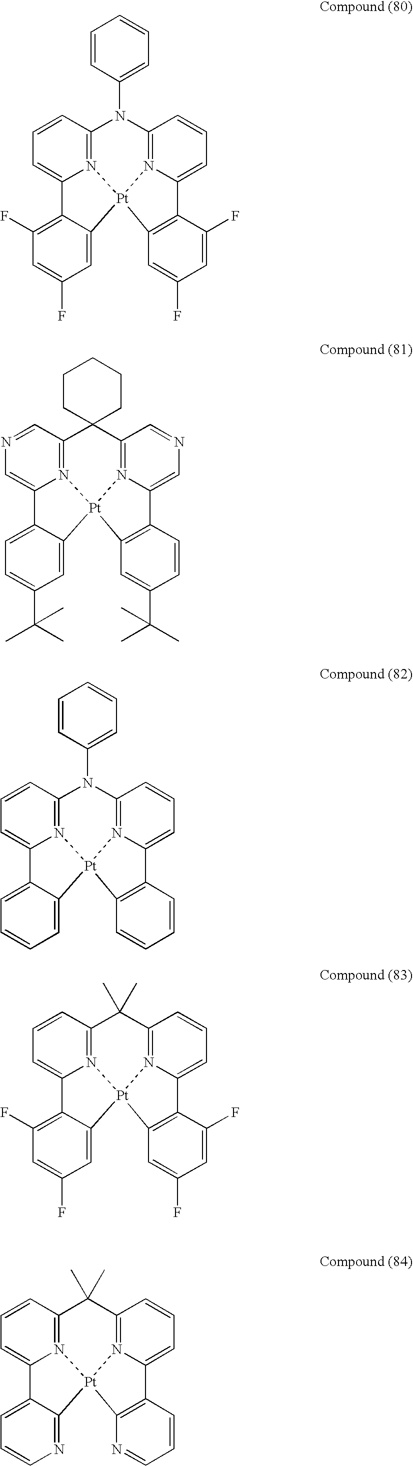

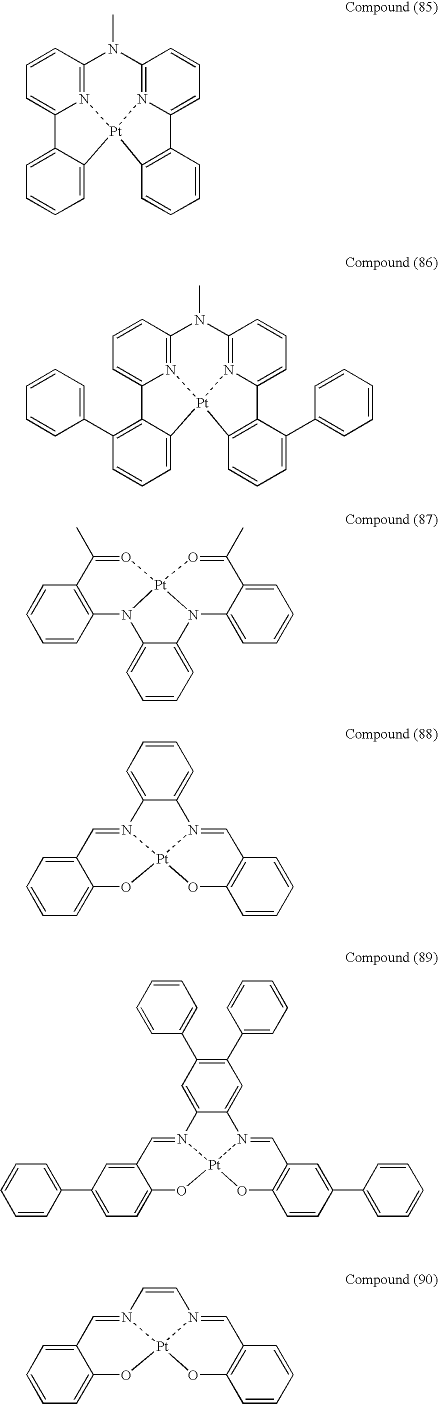

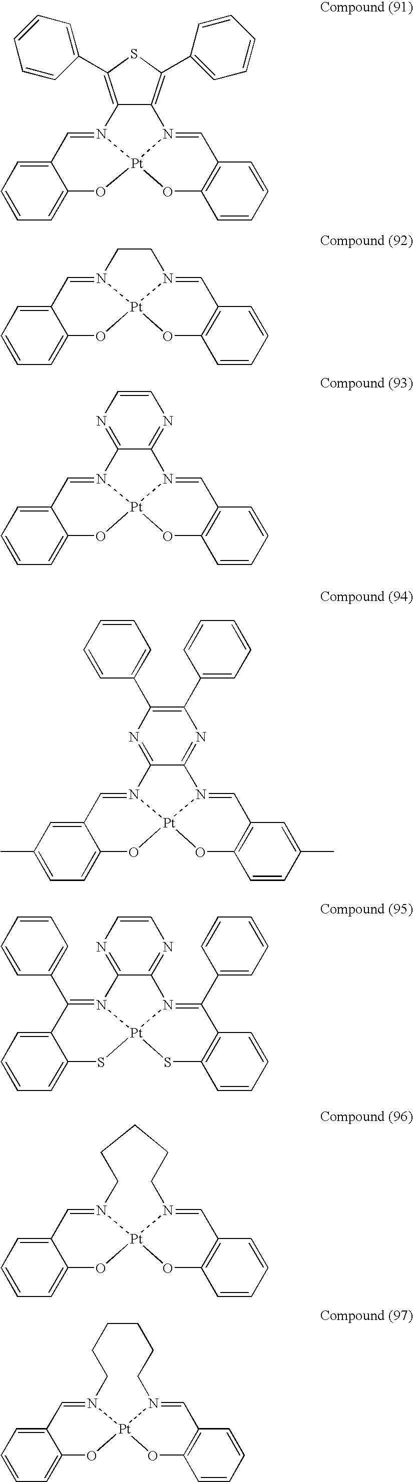

3) Second Light-Emitting Material

As the second light-emitting material in the invention, an already known hole-transporting light-emitting material may be employed. The hole-transporting light-emitting material preferably has an electron affinity (Ea) of from 2.4 eV to 3.4 eV, and an ionization potential (Ip) of from 5.0 eV to 6.3 eV.

Examples of the material which can be used preferably include complexes of ruthenium, rhodium, palladium, tungsten, rhenium, osmium, iridium, platinum, lanthanum, cerium, praseodymium, neodymium, samarium, europium, gadolinium, terbium, dysprosium, holmium, erbium, thulium, ytterbium, and lutetium, and more preferable is an iridium complex.

Specific examples of the iridium complex are shown in the following, but the invention is not limited thereto.

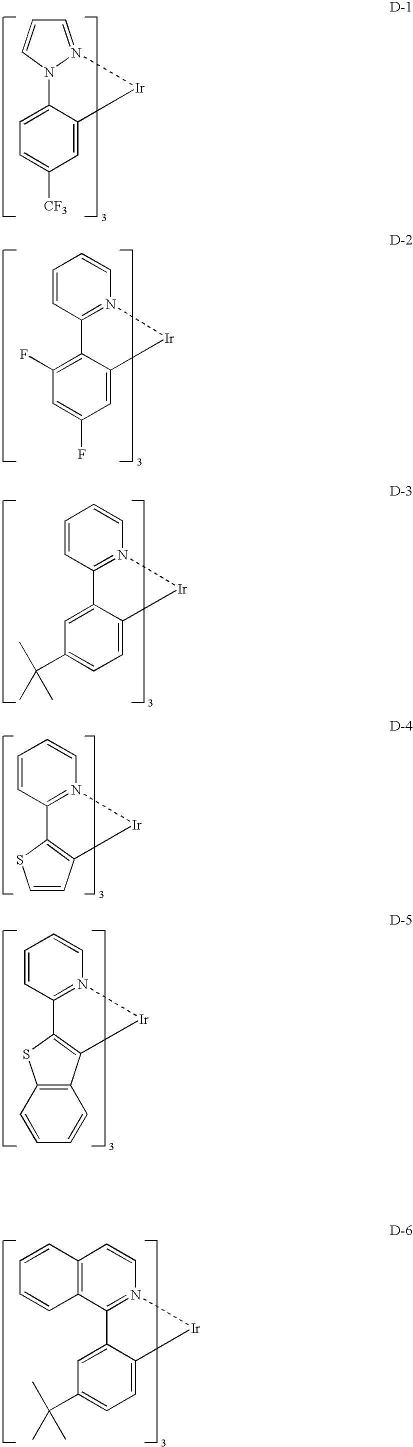

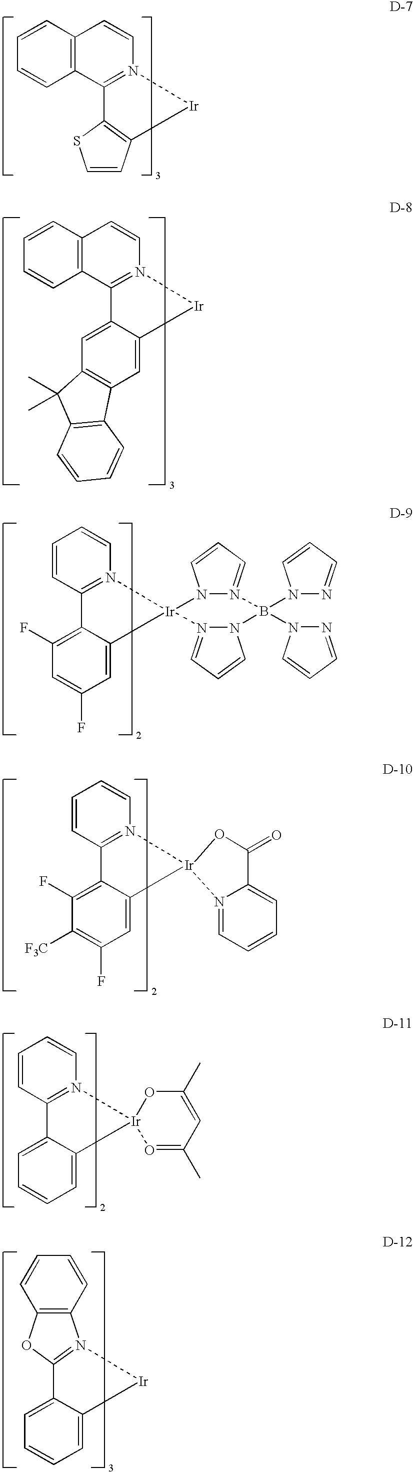

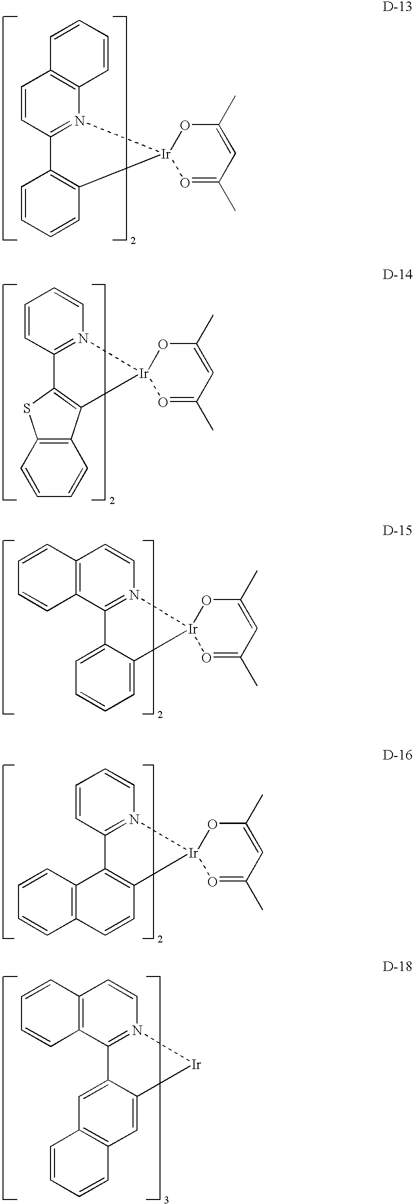

In a particularly preferably combination of the invention, the first light-emitting material is a platinum complex and the second light-emitting material is an iridium complex.

(Hole Injection Layer and Hole Transport Layer)

The hole injection layer and the hole transport layer are layers which have a function to receive a holes from an anode or an anode side and transport the holes to a cathode side.

The hole injection layer or the hole transport layer preferably contains an electron-accepting material which becomes a carrier to transport holes. Either of an inorganic compound or an organic compound may be used as the electron-accepting material introduced into the hole injection layer or the hole transport layer as long as the compound has electron accepting property and a function for oxidizing an organic compound. Specifically, Lewis acid compounds such as iron (III) chloride, aluminum chloride, gallium chloride, indium chloride, antimony pentachloride and the like are preferably used as the inorganic compounds.

In case of the organic compounds, compounds having substituents such as a nitro group, halogen, a cyano group, a trifluoromethyl group and the like; quinone compounds; acid anhydride compounds; fullerenes; and the like may be preferably applied.

Specific examples thereof include, hexacyanobutadiene, hexacyanobenzene, tetracyanoethylene, tetracyanoquinodimethane, tetrafluorotetracyanoquinodimethane, p-fluoranil, p-chloranil, p-bromanil, p-benzoquinone, 2,6-dichlorobenzoquinone, 2,5-dichlorobenzoquinone, tetramethylbenzoquinone, 1,2,4,5-tetracyanobenzene, o-dicyanobenzene, p-dicyanobenzene, 1,4-dicyanotetrafluorobenzene, 2,3-dichloro-5,6-dicyanobenzoquinone, p-dinitrobenzene, m-dinitrobenzene, o-dinitrobenzene, p-cyanonitrobenzene, m-cyanonitrobenzene, o-cyanonitrobenzene, 1,4-naphthoquinone, 2,3-dichloronaphthoquinone, 1-nitronaphthalene, 2-nitronaphthalene, 1,3-dinitronaphthalene, 1,5-dinitronaphthalene, 9-cyanoanthracene, 9-nitroanthracene, 9,10-anthraquinone, 1,3,6,8-tetranitrocarbazole, 2,4,7-trinitro-9-fluorenone, 2,3,5,6-tetracyanopyridine, maleic anhydride, phthalic anhydride, fullerene C60, C70, and the like.

Hexacyanobutadiene, hexacyanobenzene, tetracyanoethylene, tetracyanoquinodimethane, tetrafluorotetracyanoquinodimethane, p-fluoranil, p-chloranil, p-bromanil, p-benzoquinone, 2,6-dichlorobenzoquinone, 2,5-dichlorobenzoquinone, 1,2,4,5-tetracyanobenzene, 1,4-dicyanotetrafluorobenzene, 2,3-dichloro-5,6-dicyanobenzoquinone, p-dinitrobenzene, m-dinitrobenzene, o-dinitrobenzene, 1,4-naphthoquinone, 2,3-dichloronaphthoquinone, 1,3-dinitronaphthalene, 1,5-dinitronaphthalene, 9,10-anthraquinone, 1,3,6,8-tetranitrocarbazole, 2,4,7-trinitro-9-fluorenone, 2,3,5,6-tetracyanopyridine or C60 is preferred, and hexacyanobutadiene, hexacyanobenzene, tetracyanoethylene, tetracyanoquinodimethane, tetrafluorotetracyanoquinodimethane, p-fluoranil, p-chloranil, p-bromanil, 2,6-dichlorobenzoquinone, 2,5-dichlorobenzoquinone, 2,3-dichloronaphthoquinone, 1,2,4-tetracyanobenzene, 2,3-dichloro-5,6-dicyanobenzoquinone or 2,3,5,6-tetracyanopyridine is particularly preferred.

These electron-accepting materials may be used alone or in a combination of two or more of them.

Although an applied amount of these electron-accepting materials depends on the type of material, 0.01% by weight to 50% by weight is preferred with respect to a hole injection layer material or the hole transport layer material, 0.05% by weight to 20% by weight is more preferable, and 0.1% by weight to 10% by weight is particularly preferred.

In the case where the applied amount is less than 0.01% by weight with respect to the hole injection layer material, it is not preferred because the effect of the present invention is not sufficiently realized. In the case where the applied amount exceeds 50% by weight, it is not preferred because the hole injection ability is spoiled.

As a material for the hole injection layer and the hole transport layer, it is preferred to contain specifically pyrrole derivatives, carbazole derivatives, pyrazole derivatives, triazole derivatives, oxazole derivatives, oxadiazole derivatives, imidazole derivatives, polyarylalkane derivatives, pyrazoline derivatives, pyrazolone derivatives, phenylenediamine derivatives, arylamine derivatives, amino-substituted calcon derivatives, styrylanthracene derivatives, fluorenone derivatives, hydrazone derivatives, stilbene derivatives, silazane derivatives, aromatic tertiary amine compounds, styrylamine compounds, aromatic dimethylidine compounds, porphyrin compounds, organosilane derivatives, carbon or the like.

The thickness of the hole injection layer or the hole transport layer is not particularly limited, and is preferably 1 nm to 5 μm, more preferably 5 nm to 1 μm, and particularly preferably 10 nm to 500 nm from the viewpoints of decreasing driving voltage, improving light emission efficiency and improving drive durability.

The hole injection layer and the hole transport layer may be composed of a mono-layered structure comprising one or two or more of the above-mentioned materials, or a multilayer structure composed of plural layers of a homogeneous composition or heterogeneous compositions.

(Electron Injection Layer and Electron Transport Layer)

The electron injection layer and the electron transport layer are layers having any of functions for injecting electrons from the cathode, transporting electrons, and becoming a barrier to holes which could be injected from the anode.

As an electron-donating material applied to the electron injection layer or the electron transport layer, any material may be used as long as it has an electron-donating property and a property for reducing an organic compound, and alkaline metals such as Li, alkaline earth metals such as Mg, transition metals including rare-earth metals and the like are preferably used.

Particularly, metals having a work function of 4.2 eV or less are preferably applied, and specific examples thereof include Li, Na, K, Be, Mg, Ca, Sr, Ba, Y, Cs, La, Sm, Gd, and Yb.

These electron-donating materials may be used alone or in a combination of two or more of them.

An applied amount of the electron-donating dopants differs dependent on the types of the materials, but it is preferably 0.1% by weight to 99% by weight with respect to an electron transport layer material, more preferably 1.0% by weight to 80% by weight, and particularly preferably 2.0% by weight to 70% by weight.

In the case where the applied amount is less than 0.1% by weight with respect to the injection transfer layer material, it is not preferred because the effect of the present invention is not sufficiently realized. In the case where the applied amount exceeds 99% by weight, it is not preferred because the electron transfer ability is spoiled.

Specific examples of the material of the electron injection layer or electron transport layer include a pyridine derivative, a pyrimidine derivative, a triazine derivative, an imidazole derivative, a triazole derivative, an oxazole derivative, a fluorenone derivative, an anthraquinodimethane derivative, an anthrone derivative, a diphenylquinone derivative, a thiopyran dioxide derivative, a carbodiimide derivative, a fluorenylidenemethane derivative, a distyrylpyrazine derivative, a fluorine-substituted aromatic compound, a heterocyclic tetracarboxylic anhydride of an aromatic compound such as naphthalene or perylene and the derivative thereof, a phthalocyanine derivative, various metal complexes as typically represented by a metal complex of a 8-quinolinol derivative or metal phthalocyanine, a metal complex containing benzoxazole or benzothiazole as a ligand.

A thickness of the electron injection layer and the electron transport layer is preferably 1 nm to 5 μm, respectively in view of decreasing driving voltage, improving light emission efficiency and improving drive durability. The thickness thereof is preferably 5 nm to 1 μm, more preferably is 10 nm to 500 nm. The electron injection layer and the electron transport layer may have either a monolayered structure comprising one or two or more of the above-mentioned materials, or a multilayer structure composed of plural layers of a homogeneous composition or a heterogeneous composition.

(Hole-Blocking Layer)

A hole-blocking layer is a layer having a function to prevent the holes transported from the anode to the light-emitting layer from passing through to the cathode side. According to the present invention, a hole-blocking layer may be provided as an organic compound layer adjacent to the light-emitting layer on the cathode side.

The hole-blocking layer is not particularly limited, but specifically, it may contain an aluminum complex such as BAlq, a triazole derivative, a pyrazabole derivative, or the like.

It is preferred that a thickness of the hole-blocking layer is preferably 50 nm or less in order to decrease driving voltage, more preferably it is 1 nm to 50 nm, and even more preferably it is 5 nm to 40 nm.

(Anode)

The anode may generally have a function as an electrode for supplying holes to the organic compound layer, and while there is no particular limitation as to the shape, the structure, the size and the likes it may be suitably selected from among well-known electrode materials according to the application and the purpose thereof. As described above, the anode is generally disposed as a transparent anode.

As materials for the anode, for example, metals, alloys, metal oxides, electric conductive compounds, and mixtures thereof are preferably used, wherein those having a work function of 4.0 eV or more are preferred. Specific examples of the anode materials include electric conductive metal oxides such as tin oxides doped with antimony, fluorine or the like (ATO, and FTO), tin oxide, zinc oxide, indium oxide, indium tin oxide (ITO), and indium zinc oxide (IZO); metals such as gold, silver, chromium, and nickel, mixtures or laminates of these metals and the electric conductive metal oxides; inorganic electric conductive materials such as copper iodide, and copper sulfide; organic electric conductive materials such as polyaniline, polythiophene, and polypyrrole; and laminates of these inorganic or organic electron-conductive materials with ITO. Among these, preferred are electric conductive metal oxides, and particularly, ITO is preferred from view points of productivity, high electric conductivity, transparency and the like.

The anode may be formed on the substrate, for example, in accordance with a method which is appropriately selected from among wet methods such as a printing method, and a coating method and the like; physical methods such as a vacuum deposition method, a sputtering method, and an ion plating method and the like; and chemical methods such as CVD and plasma CVD methods and the like with consideration of the suitability with a material constituting the anode. For instance, when ITO is selected as a material for the anode, the anode may be formed in accordance with a DC or high-frequency sputtering method, a vacuum deposition method, an ion plating method or the like.

In the organic electroluminescence device of the present invention, a position at which the anode is to be formed is not particularly restricted, but it may be suitably selected according to the application and the purpose of the luminescent device. The anode may be formed on either the whole surface or a part of the surface on either side of the substrate.

For patterning to form the anode, a chemical etching method such as photolithography, a physical etching method such as etching by laser, a method of vacuum deposition or sputtering through superposing masks, and a lift-off method or a printing method may be applied.

A thickness of the anode may be suitably selected dependent on the material constituting the anode, and is not definitely decided, but it is usually in the range of around 10 nm to 50 μm, and 50 nm to 20 μm is preferred.

A value of electric resistance of the anode is preferably 10³Ω/□ or less, and 10²Ω/□ or less is more preferable. In the case where the anode is transparent, it may be colorless and transparent or colored and transparent. For extracting luminescence from the transparent anode side, it is preferred that a light transmittance of the anode is 60% or higher, and more preferably 70% or higher.

Concerning the transparent anode, there is a detailed description in “TOUMEI DENNKYOKU-MAKU NO SHINTENKAI (Novel Developments in Transparent Electrode Films)” edited by Yutaka Sawada and published by C.M.C. in 1999, the contents of which are incorporated by reference herein. In the case where a plastic substrate of a low heat resistance is applied, it is preferred that ITO or IZO is used to obtain a transparent anode prepared by forming the film at a low temperature of 150° C. or lower.

(Cathode)

The cathode may generally have a function as an electrode for injecting electrons to the organic compound layer, and there is no particular restriction as to the shape, the structure, the size and the like. Accordingly, the cathode may be suitably selected from among well-known electrode materials.

As the materials constituting the cathode, for example, metals, alloys, metal oxides, electric conductive compounds, and mixtures thereof may be used, wherein materials having a work function of 4.5 eV or less are preferred. Specific examples include alkali metals (e.g., Li, Na, K, Cs or the like); alkaline earth metals (e.g., Mg, Ca or the like); gold; silver; lead; aluminum; sodium-potassium alloys; lithium-aluminum alloys; magnesium-silver alloys; rare earth metals such as indium and ytterbium; and the like. They may be used alone, but it is preferred that two or more of them are used in combination from the viewpoint of satisfying both of stability and electron injectability.

Among these, as the materials for constituting the cathode, alkaline metals or alkaline earth metals are preferred in view of electron injectability, and materials containing aluminum as the major component are preferred in view of excellent preservation stability.

The term “material containing aluminum as the major component” refers to a material that material exists in the form of aluminum alone; alloys comprising aluminum and 0.01% by weight to 10% by weight of an alkaline metal or an alkaline earth metal; or mixtures thereof (e.g., lithium-aluminum alloys, magnesium-aluminum alloys and the like).

As for materials for the cathode, they are described in detail in JP-A Nos. 2-15595 and 5-121172, the contents of which are incorporated by reference herein.

A method for forming the cathode is not particularly limited, but it may be formed in accordance with a well-known method.

For instance, the cathode may be formed in accordance with a method which is appropriately selected from among wet methods such as a printing method, and a coating method and the like; physical methods such as a vacuum deposition method, a sputtering method, and an ion plating method and the like; and chemical methods such as CVD and plasma CVD methods and the like, while taking the suitability to a material constituting the cathode into consideration. For example, when a metal (or metals) is (are) selected as a material (or materials) for the cathode, one or two or more of them may be applied at the same time or sequentially in accordance with a sputtering method or the like.

For patterning to form the cathode, a chemical etching method such as photolithography, a physical etching method such as etching by laser, a method of vacuum deposition or sputtering through superposing masks, and a lift-off method or a printing method may be applied.

In the present invention, a position at which the cathode is to be formed is not particularly restricted, but it may be formed on either the whole or a part of the organic compound layer.

Furthermore, a dielectric material layer made of a fluoride, an oxide or the like of an alkaline metal or an alkaline earth metal may be inserted in between the cathode and the organic compound layer with a thickness of 0.1 nm to 5 nm, wherein the dielectric layer may serve as one kind of electron injection layer. The dielectric material layer may be formed in accordance with, for example, a vacuum deposition method, a sputtering method, an ion-plating method or the like.

A thickness of the cathode may be suitably selected dependent on materials for constituting the cathode and is not definitely decided, but it is usually in the range of around 10 nm to 5 μm, and 50 nm to 1 μm is preferred.

Moreover, the cathode may be transparent or opaque. The transparent cathode may be formed by preparing a material for the cathode with a small thickness of 1 nm to 10 μm, and further laminating a transparent electric conductive material such as ITO or IZO thereon.

(Substrate)

According to the present invention, a substrate may be applied. The substrate to be applied is preferably one which does not scatter or attenuate light emitted from the organic compound layer. Specific examples of materials for the substrate include zirconia-stabilized yttrium (YSZ); inorganic materials such as glass; polyesters such as polyethylene terephthalate, polybutylene phthalate, and polyethylene naphthalate; and organic materials such as polystyrene, polycarbonate, polyethersulfone, polyarylate, polyimide, polycycloolefin, norbornene resin, poly(chlorotrifluoroethylene), and the like.

For instance, when glass is used as the substrate, non-alkali glass is preferably used with respect to the quality of material in order to decrease ions eluted from the glass. In the case of employing soda-lime glass, it is preferred to use glass on which a barrier coat such as silica has been applied. In the case of employing an organic material, it is preferred to use a material excellent in heat resistance, dimension stability, solvent resistance, electrical insulation, and workability.

There is no particular limitation as to the shape, the structure, the size or the like of the substrate, but it may be suitably selected according to the application, purposes and the like of the luminescent device. In general, a plate-like substrate is preferred as the shape of the substrate. A structure of the substrate may be a monolayer structure or a laminated structure. Furthermore, the substrate may be formed from a single member or two or more members.

Although the substrate may be in a transparent and colorless, or a transparent and colored condition, it is preferred that the substrate is transparent and colorless from the viewpoint that the substrate does not scatter or attenuate light emitted from the organic light emitting layer.

A moisture permeation preventive layer (gas barrier layer) may be provided on the front surface or the back surface of the substrate.

For a material of the moisture permeation preventive layer (gas barrier layer), inorganic substances such as silicon nitride and silicon oxide may be preferably applied. The moisture permeation preventive layer (gas barrier layer) may be formed in accordance with, for example, a high-frequency sputtering method or the like.

In the case of applying a thermoplastic substrate, a hard-coat layer or an under-coat layer may be further provided as needed.

(Protective Layer)

According to the present invention, the whole organic EL device may be protected by a protective layer.

A material contained in the protective layer may be one having a function to prevent penetration of substances such as moisture and oxygen, which accelerate deterioration of the device, into the device.

Specific examples thereof include metals such as In, Sn, Pb, Au, Cu, Ag, Al, Ti, Ni and the like; metal oxides such as MgO, SiO, SiO₂, Al₂O₃, GeO, NiO, CaO, BaO, Fe₂O₃, Y₂O₃, TiO₂ and the like; metal nitrides such as SiNₓ, SiNₓO_{y} and the like; metal fluorides such as MgF₂, LiF, AlF₃, CaF₂ and the like; polyethylene; polypropylene; polymethyl methacrylate; polyimide; polyurea; polytetrafluoroethylene; polychlorotrifluoroethylene; polydichlorodifluoroethylene; a copolymer of chlorotrifluoroethylene and dichlorodifluoroethylene; copolymers obtained by copolymerizing a monomer mixture containing tetrafluoroethylene and at least one comonomer; fluorine-containing copolymers each having a cyclic structure in the copolymerization main chain; water-absorbing materials each having a coefficient of water absorption of 1% or more; moisture permeation preventive substances each having a coefficient of water absorption of 0.1% or less; and the like.

There is no particular limitation as to a method for forming the protective layer. For instance, a vacuum deposition method, a sputtering method, a reactive sputtering method, an MBE (molecular beam epitaxial) method, a cluster ion beam method, an ion plating method, a plasma polymerization method (high-frequency excitation ion plating method), a plasma CVD method, a laser CVD method, a thermal CVD method, a gas source CVD method, a coating method, a printing method, or a transfer method may be applied.

(Sealing)

The whole organic electroluminescence device of the present invention may be sealed with a sealing cap.

Furthermore, a moisture absorbent or an inert liquid may be used to seal a space defined between the sealing cap and the luminescent device. Although the moisture absorbent is not particularly limited, specific examples thereof include barium oxide, sodium oxide, potassium oxide, calcium oxide, sodium sulfate, calcium sulfate, magnesium sulfate, phosphorus pentoxide, calcium chloride, magnesium chloride, copper chloride, cesium fluoride, niobium fluoride, calcium bromide, vanadium bromide, molecular sieve, zeolite, magnesium oxide and the like. Although the inert liquid is not particularly limited, specific examples thereof include paraffins; liquid paraffins; fluorocarbon solvents such as perfluoroalkanes, perfluoroamines, perfluoroethers and the like; chlorine solvents; silicone oils; and the like.

In the organic electroluminescence device of the present invention, when a DC (AC components may be contained as needed) voltage (usually 2 volts to 15 volts) or DC is applied across the anode and the cathode, luminescence can be obtained.

The driving durability of the organic electroluminescence device according to the present invention can be determined based on the brightness halftime at a specified brightness. For instance, the brightness halftime may be determined by using a source measure unit, model 2400, manufactured by KEITHLEY to apply a DC voltage to the organic EL device to cause it to emit light, conducting a continuous driving test under the condition that the initial brightness is 2000 cd/m² defining the time required for the brightness to reach 1000 cd/m² as the brightness decaying time, and then comparing the resulting brightness decaying time with that of a conventional luminescent device. According to the present invention, the numerical value thus obtained was used.

An important characteristic parameter of the organic electroluminescence device of the present invention is external quantum efficiency. The external quantum efficiency is calculated by “the external quantum efficiency (φ)=the number of photons emitted from the device/the number of electrons injected to the device”, and it may be said that the larger the value obtained is, the more advantageous the device is in view of electric power consumption.

Moreover, the external quantum efficiency of the organic electroluminescence device is decided by “the external quantum efficiency (φ)=the internal quantum efficiency×light-extraction efficiency”. In an organic EL device which utilizes the fluorescent luminescence from the organic compound, an upper limit of the internal quantum efficiency is 25%, while the light-extraction efficiency is about 20%, and accordingly, it is considered that an upper limit of the external quantum efficiency is about 5%.

As the numerical value of the external quantum efficiency, the maximum value thereof when the device is driven at 20° C., or a value of the external quantum efficiency at about 100 cd/m² to 300 cd/m² (preferably 200 cd/m²), when the device is driven at 20° C. may be used.

According to the present invention, a value obtained by the following method is used. Namely, a DC constant voltage is applied to the EL device by the use of a source measure unit, model 2400, manufactured by KEITHLEY to cause it to emit light, the brightness of the light is measured by using a brightness photometer (trade name: BM-8, manufactured by Topcon Corporation), and then, the external quantum efficiency at 200 cd/m² is calculated.

Further, an external quantum efficiency of the luminescent device may be obtained by measuring the luminescent brightness, the luminescent spectrum, and the current density, and calculating the external quantum efficiency from these results and a specific visibility curve. In other words, using the current density value, the number of electrons injected can be calculated. By an integration calculation using the luminescent spectrum and the specific visibility curve (spectrum), the luminescent brightness can be converted into the number of photons emitted.

From the result, the external quantum efficiency (%) can be calculated by “(the number of photons emitted/the number of electrons injected to the device)×100”.

For the driving method of the organic electroluminescence device of the present invention, driving methods described in JP-A Nos. 2-148687, 6-301355, 5-29080, 7-134558, 8-234685, and 8-241047; Japanese Patent No. 2784615, U.S. Pat. Nos. 5,828,429 and 6,023,308 are applicable.

(Application of the Organic Electroluminescence Device of the Present Invention)

The organic electroluminescence device of the present invention can be appropriately used for indicating devices, displays, backlights, electronic photographs, illumination light sources, recording light sources, exposure light sources, reading light sources, signages, advertising displays, interior accessories, optical communications and the like.

All publications, patent applications, and technical standards mentioned in this specification are herein incorporated by reference to the same extent as if each individual publication, patent application, or technical standard was specifically and individually indicated to be incorporated by reference.

### EXAMPLES

In the following, the organic electroluminescence device of the present invention will be explained by examples thereof, but the invention is by no means limited by such examples.

### Example 1

### 1. Preparation of Organic EL Device

1) Preparation of Device No. 1 of the Invention

A glass substrate having an evaporated layer of indium-tin oxide (which is referred to hereinafter as ITO in some cases) (manufactured by Geomatec Co., Ltd., surface resistance: 10Ω/□, size: 0.5 mm in thickness and 2.5 cm square) was placed in a washing vessel, subjected to an ultrasonic washing in 2-propanol and subjected to a UV-ozone treatment for 30 minutes. On this transparent anode, following layers were vacuum evaporated in succession. In the examples of the invention, the evaporation rate is 0.2 nm/sec unless specified otherwise. The evaporation rate was measured with a crystal oscillator. Also film thicknesses described in the following were measured with a crystal oscillator.

—Hole Injection Layer—

4,4′,4″-tris(2-naphthylphenylamino)triphenylamine (which is referred to hereinafter as 2-TNATA in some cases) was doped with 2,3,5,6-tetrafluoro-7,7,8,8-tetracyanoquinodimethane (which is referred to hereinafter as F4-TCNQ in some cases) in an amount of 1.0% by weight, and was evaporated with a film thickness of 160 nm on the ITO film.

—Hole Transport Layer—

On the hole injection layer, N,N′-dinaphthyl-N,N′-diphenyl-[1,1′-biphenyl]-4,4′-diamine (which is referred to hereinafter as α-NPD in some cases) was evaporated with a film thickness of 1 nm.

—Light-Emitting Layer—

A layer containing a following inactive compound 1 as the electrically inactive material, a following electron-transporting light-emitting material A as the first light-emitting material, and hole-transporting Ir(ppy)₃ as the second light-emitting material was formed by co-evaporation with a film thickness of 5 nm. The inactive compound 1, the first light-emitting material and the second light-emitting material had a ratio of 70:15:15 by weight.

—Electron Transport Layer—

Aluminum (III) bis(2-methyl-8-quinolinate)-4-phenylphenolate (which is referred to hereinafter as Balq in some cases) was evaporated with a film thickness of 1 nm.

—Electron Injection Layer—

Tris(8-hydroxyquinonynate)aluminum (which is referred to hereinafter as Alq in some cases) and lithium (Li), in an amount 1% by weight with respect to Alq, were co-evaporated with an evaporation thickness of 30 nm.

—Cathode—

A patterned mask (providing a light emission area of 2 mm×2 mm) was disposed thereon, then lithium fluoride (LiF) was evaporated with a thickness of 0.5 nm and aluminum metal was evaporated with a thickness of 100 nm to form a cathode.

The laminate member thus produced was placed in a glove box substituted with argon gas, and was sealed utilizing a stainless steel sealing container and an ultraviolet-curable adhesive (XNR5516RV, manufactured by Nagase-Ciba Co., Ltd.).

2) Preparation of Devices Nos. 2 to 9 of the Invention

In the preparation of the device No. 1, the thickness of the light-emitting layer and the electrically inactive material were changed as shown in Table 1 to prepare devices Nos. 2 to 9 of the invention.

TABLE 1

| | Inactive | Thickness of Light- |
|---|---|---|
| Device No. | Material | emitting Layer (nm) |
| Device of Invention 1 | Compound 1 | 5 |
| Device of Invention 2 | Compound 1 | 10 |
| Device of Invention 3 | Compound 1 | 1 |
| Device of Invention 4 | Compound 1 | 20 |
| Device of Invention 5 | Compound 2 | 5 |
| Device of Invention 6 | Compound 3 | 5 |
| Device of Invention 7 | Compound 4 | 5 |
| Device of Invention 8 | Compound 5 | 5 |
| Device of Invention 9 | SiO | 5 |

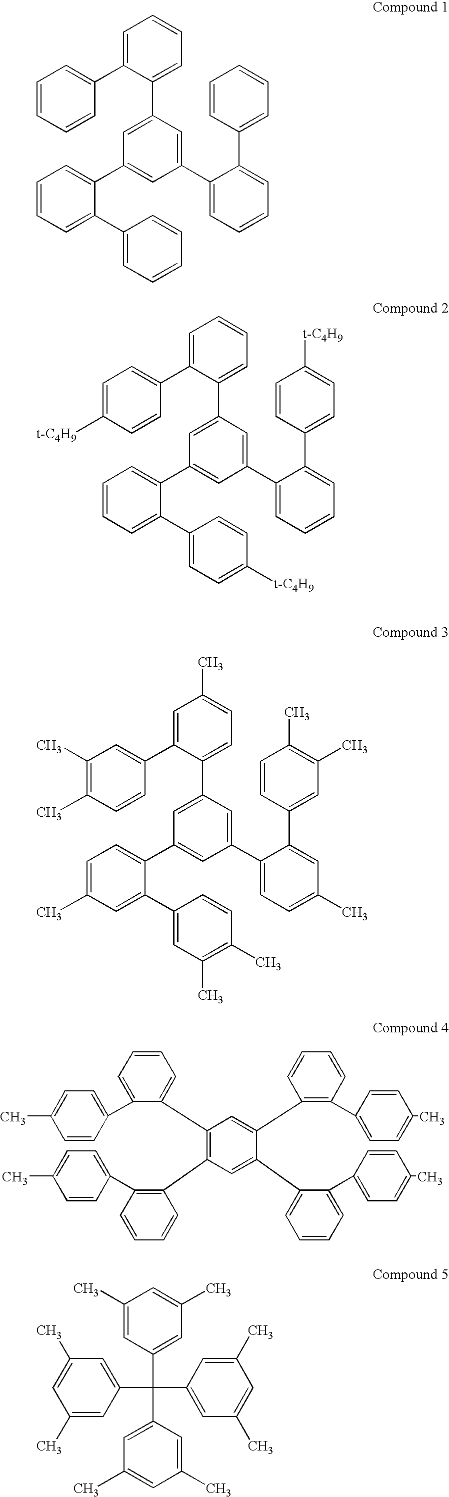

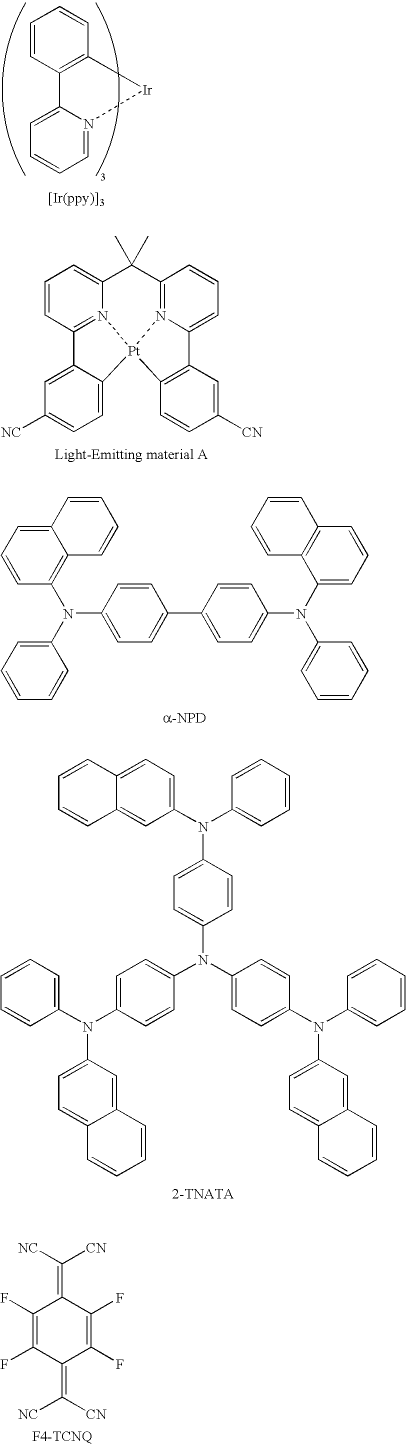

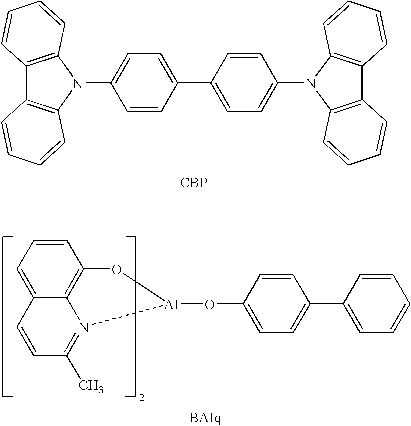

3) Preparation of Comparative Devices

Comparative device a: In the device No. 1, the thickness of the light-emitting layer was changed to 30 nm.

Comparative device b: It was prepared in the similar manner to the device No. 1, except for employing a layer having the following composition as the light-emitting layer.

Comparative light-emitting layer: CBP and Ir(ppy)₃, in a proportion of 15% by weight with respect to CBP, were co-evaporated, with a thickness of 10 nm. CBP is a hole-transporting host material, and Ir(ppy)₃ is a hole-transporting light-emitting material.

Comparative device c: It was prepared in the similar manner to the device No. 1, except for employing a layer of the following composition as the light-emitting layer.

Comparative light-emitting layer: The inactive compound 1, CBP in a proportion of 40% by weight with respect to the inactive compound 1, and Ir(ppy)₃, in a proportion of 15% by weight with respect to the inactive compound 1, were co-evaporated, with a thickness of 10 nm. CBP is a hole-transporting host material, and Ir(ppy)₃ is a hole-transporting light-emitting material. Therefore, the composition of the light-emitting layer in the comparative device c contains two hole-transport materials with respect to the inactive material, and is different from the composition of the invention.

The electron affinity (Ea) and the ionization potential (Ip) of the materials employed in the light-emitting layers of the devices of invention and of the comparative devices are shown in Table 2.

The Eg is 4.0 eV or higher in each of the inactive compounds 1 to 5, but it is less than 4.0 eV in the materials employed in the comparative devices.

Also in the light-emitting material A constituting the first light-emitting material and the Ir(ppy)₃ constituting the second light-emitting material of the devices of the invention, Ea and Ip are larger in the light-emitting material A, respectively by 0.1 eV and 0.4 eV, than in Ir(ppy)₃. On the other hand, in the two light-emitting materials (host and dopant) in the comparative device c, Ea is larger in Ir(ppy)₃ than in CBP, and, in contrast, Ip is larger in CBP than in Ir(ppy)₃.

TABLE 2

| Compound | Ip (eV) | Ea (eV) | Eg (eV) |
|---|---|---|---|
| Inactive Compound 1 | 6.3 | 2.1 | 4.2 |
| Inactive Compound 2 | 6.2 | 2.1 | 4.1 |
| Inactive Compound 3 | 6.3 | 2.1 | 4.2 |
| Inactive Compound 4 | 6.2 | 2.1 | 4.1 |
| Inactive Compound 5 | 6.2 | 2.2 | 4 |
| CBP | 6.0 | 2.5 | 3.5 |
| Ir(ppy)₃ | 5.4 | 2.8 | 2.6 |
| Light-emitting Material A | 5.8 | 2.9 | 2.9 |

### 2. Evaluation of Performance

### (Evaluation Items)

(1) Light Emission Efficiency

An external quantum efficiency of the light-emitting device was calculated from the results of measurements of a light-emission luminance, a light-emission spectrum and a current density, and a relative luminosity curve. The external quantum efficiency (%) was calculated by “(number of emitted photons/number of input electrons to the device)×100”.

(2) Drive Voltage

The drive voltage at an luminance of 2000 cd/m² was measured.

(3) Drive Durability

A continuous driving test was conducted under an initial luminance of 2000 cd/m², and a time at which the luminance was reduced to a half was determined as a durable time.

### (Results of Evaluations)

The obtained results are shown in Table 3.

The devices of the invention resulted in unexpectedly high light emission efficiency in comparison with the devices of comparative examples, and also achieved unexpectedly long drive durability. In spite of such drastic improvements in these characteristics, the drive voltage unexpectedly remained same or was even lower depending on the devices.

In the comparative device a, having a light-emitting layer of a thickness of 30 nm, the drive voltage showed a significant increase, and the light emission efficiency was low.

In the comparative devices b and c, the light emission efficiency was low, and the comparative device c was significantly inferior in the drive durability.

TABLE 3

| | | | Half-reduction |
|---|---|---|---|
| | Drive | Light Emission | Time of |
| Device No. | Voltage (V) | Efficiency (%) | Luminance (H) |
| Device of Invention 1 | 5 | 15 | 3200 |
| Device of Invention 2 | 7 | 15 | 3200 |
| Device of Invention 3 | 3 | 13 | 2800 |
| Device of Invention 4 | 10 | 12 | 2500 |
| Device of Invention 5 | 5 | 14 | 3000 |
| Device of Invention 6 | 5 | 15 | 3200 |
| Device of Invention 7 | 5 | 12 | 2800 |
| Device of Invention 8 | 5 | 12 | 2500 |
| Device of Invention 9 | 5 | 13 | 2800 |
| Comparative Device a | 13 | 7 | 1800 |
| Comparative Device b | 6 | 7 | 1200 |
| Comparative Device c | 5 | 5 | 700 |

What is claimed is:

1. An organic electroluminescence device comprising, between a pair of electrodes opposed to each other, an organic compound layer including at least a light-emitting layer, wherein the light-emitting layer contains at least a first light-emitting material and a second light-emitting material, and an electrically inactive material having an energy difference (Eg) between a highest occupied molecular orbital and a lowest unoccupied molecular orbital of 4.0 eV or larger, wherein:
the first light-emitting material is an electron-transporting light-emitting material,
the second light-emitting material is a hole-transporting light-emitting material, and
the light-emitting layer has a thickness within a range of from 0.5 nm to 20 nm.

2. The organic electroluminescence device according to claim 1, wherein:
an electron affinity (Ea1) of the first light-emitting material is larger than an electron affinity (Ea2) of the second light-emitting material, and
an ionization potential (Ip1) of the first light-emitting material is larger than an ionization potential (Ip2) of the second light-emitting material.

3. The organic electroluminescence device according to claim 1, wherein the first light-emitting material is a platinum complex.

4. The organic electroluminescence device according to claim 1, wherein the second light-emitting material is an iridium complex.

5. The organic electroluminescence device according to claim 1, wherein the first light-emitting material is a platinum complex, and the second light-emitting material is an iridium complex.

6. The organic electroluminescence device according to claim 1, wherein the light-emitting layer has a thickness within a range of from 1 nm to 10 nm.

7. The organic electroluminescence device according to claim 1, wherein a proportion of the light-emitting materials with respect to a total amount of the light-emitting materials and the electrically inactive material in the light-emitting layer is from 5% to 40% by weight.

8. The organic electroluminescence device according to claim 1, wherein the electrically inactive material is an organic compound having an ionization potential (Ip) larger than that of the light-emitting material.

9. The organic electroluminescence device according to claim 1, wherein the electrically inactive material is an organic compound having an electron affinity (Ea) smaller than that of the light-emitting material.

10. The organic electroluminescence device according to claim 1, wherein the electrically inactive material is an aromatic hydrocarbon compound.

11. The organic electroluminescence device according to claim 10, wherein the aromatic hydrocarbon compound is a compound represented by the following formula (1):
L-(Ar)ₘ Formula (1)
wherein, in formula (1), Ar represents a group represented by the following formula (2); L represents a benzene skeleton having a valency of 3 or more; and m represents an integer of 3 or more: 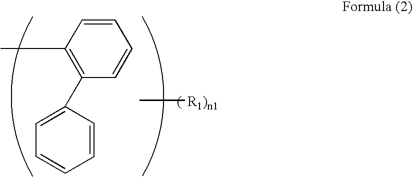
wherein, in formula (2), R¹ represents a substituent, with a proviso that, if plural R¹s are present, R¹s may be the same or different from each other; and n1 represents an integer from 0 to 9.

12. The organic electroluminescence device according to claim 10, wherein the aromatic hydrocarbon compound is a compound represented by the following formula (3): 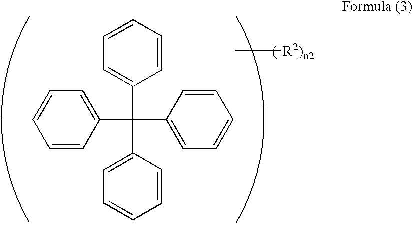
wherein, in formula (3), R² represents a substituent, with a proviso that, if plural R²s are present, R²s may be the same or different from each other; and n2 represents an integer from 0 to 20.

13. The organic electroluminescence device according to claim 1, wherein the electrically inactive material is an insulating inorganic compound.

14. The organic electroluminescence device according to claim 1, wherein the organic compound layer includes, from an anode side, at least either one of a hole injection layer and a hole transport layer, the light-emitting layer, and at least either one of an electron transport layer and an electron injection layer, and at least either one of the hole injection layer and the hole transport layer contains an electron-accepting material.

15. The organic electroluminescence device according to claim 1, wherein the organic compound layer includes, from an anode side, at least either one of a hole injection layer and a hole transport layer, the light-emitting layer, and at least either one of an electron transport layer and an electron injection layer, and at least either one of the electron transport layer and the electron injection layer contains an electron-donating material.
